(19) United States
(12) Patent Application Publication
(10) Pub. No.: US 2017/0273083 A1
(43) Pub. Date: Sep. 21, 2017

(54) TONE PLAN ADAPTATION FOR CHANNEL BONDING IN WIRELESS COMMUNICATION NETWORKS

(71) Applicant: QUALCOMM Incorported, San Diego, CA (US)

(72) Inventors: Jialing Li Chen, San Diego, CA (US); Lin Yang, San Diego, CA (US); Sameer Vermani, San Diego, CA (US); Bin Tian, San Diego, CA (US)

(21) Appl. No.: 15/460,094

(22) Filed: Mar. 15, 2017

Related U.S. Application Data
(60) Provisional application No. 62/309,367, filed on Mar. 16, 2016.

(51) Int. Cl. H04W 72/04; H04L 1/00; H04L 5/00

(52) U.S. Cl. CPC H04W 72/0453; H04L 5/0053; H04L 1/0071

(57) ABSTRACT

Methods and apparatuses are disclosed for communicating over a wireless communication network. One such apparatus can include a memory that stores instructions and a processor coupled with the memory. The processor and the memory can be configured to identify one or more impacted tones of one or more resource units (RUs) overlapping a null sub-band, or guard band thereof, of a plurality of sub-bands available for wireless communication. The processor can be further configured to allocate, or receive allocation of, a plurality of channel bonded resource units (RU) of the plurality of sub-bands, based at least in part on the identified impacted tones. The apparatus further includes a transmitter configured to transmit data over the plurality of channel bonded RUs.

### CLAIM OF PRIORITY UNDER 35 U.S.C. §119

The present application for patent claims priority to Provisional Application No. 62/309,367 entitled “TONE PLAN ADAPTATION FOR CHANNEL BONDING IN WIRELESS COMMUNICATION NETWORKS” filed Mar. 16, 2016, and assigned to the assignee hereof. Provisional Application No. 62/309,367 is hereby expressly incorporated by reference herein.

### FIELD

Certain aspects of the present disclosure generally relate to wireless communications, and more particularly, to methods and apparatuses for allocating and bonding wireless communication channels.

### BACKGROUND

In many telecommunication systems, communications networks can be used to exchange messages among several interacting spatially-separated devices. Networks can be classified according to geographic scope, which could be, for example, a metropolitan area, a local area, or a personal area. Such networks can be designated respectively as a wide area network (WAN), metropolitan area network (MAN), local area network (LAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, SONET (Synchronous Optical Networking), Ethernet, etc.).

Wireless networks can be often preferred when the network elements can be mobile and thus have dynamic connectivity needs, or if the network architecture is formed in an ad hoc, rather than fixed, topology. Wireless networks employ intangible physical media in an unguided propagation mode using electromagnetic waves in the radio, microwave, infrared, optical, etc. frequency bands. Wireless networks advantageously facilitate user mobility and rapid field deployment when compared to fixed wired networks.

The devices in a wireless network can transmit/receive information between each other. Device transmissions can interfere with each other, and certain transmissions can selectively block other transmissions. Where many devices can be a communication network, congestion and inefficient link usage can result. As such, systems, methods, and non-transitory computer-readable media can be needed for improving communication efficiency in wireless networks.

### SUMMARY

Various implementations of systems, methods and devices within the scope of the appended claims each have several aspects, no single one of which can be solely responsible for the desirable attributes described herein. Without limiting the scope of the appended claims, some prominent features can be described herein.

Details of one or more implementations of the subject matter described in this specification can be set forth in the accompanying drawings and the description below. Other features, aspects, and advantages will become apparent from the description, the drawings, and the claims. Note that the relative dimensions of the following figures may not be drawn to scale.

One aspect of the disclosure provides an apparatus configured to communicate over a wireless communication network. The apparatus includes a memory that stores instructions, a processor coupled with the memory, wherein the processor and the memory are configured to: identify one or more impacted tones of one or more resource units (RUs) overlapping a null sub-band, or guard band thereof, of a plurality of sub-bands available for wireless communication; and allocate, or receive allocation of, a plurality of channel bonded resource units (RUs) within the plurality of sub-bands, based at least in part on the one or more impacted tones. He apparatus further includes a transmitter configured to transmit data over the plurality of channel bonded RUs.

Another aspect provides a method of communicating over a wireless communication network. The method includes identifying one or more impacted tones of one or more resource units (RUs) overlapping a null sub-band, or guard band thereof, of a plurality of sub-bands available for wireless communication; allocating, or receiving allocation of, a plurality of channel bonded resource units (RU) within the plurality of sub-bands, based at least in part on the one or more impacted tones; and transmitting data over the plurality of channel bonded RUs.

Another aspect provides another apparatus for communicating over a wireless communication network. The apparatus includes means for identifying one or more impacted tones of one or more resource units (RUs) overlapping a null sub-band, or guard band thereof, of a plurality of sub-bands available for wireless communication; means for allocating, or receiving allocation of, a plurality of channel bonded resource units (RU) within the plurality of sub-bands, based at least in part on the one or more impacted tones; and means for transmitting data over the plurality of channel bonded RUs.

Another aspect provides a non-transitory computer readable medium. The medium includes code that, when executed, causes an apparatus to identify one or more impacted tones of one or more resource units (RUs) overlapping a null sub-band, or guard band thereof, of a plurality of sub-bands available for wireless communication; allocate, or receive allocation of, a plurality of channel bonded resource units (RU) within the plurality of sub-bands, based at least in part on the one or more impacted tones; and transmit data over the plurality of channel bonded RUs.

### BRIEF DESCRIPTION OF THE DRAWINGS

FIG. 1 illustrates an example of a wireless communication system in which aspects of the present disclosure can be employed.

FIG. 2 illustrates various components that can be utilized in a wireless device that can be employed within the wireless communication system of FIG. 1.

FIG. 3 shows an example 2N-tone plan, according to one embodiment.

FIG. 4 is an illustration of a 20 MHz, a 40 MHz, and an 80 MHz transmission.

FIGS. 5A-5C show example 20 MHz, 40 MHz, and 80 MHz transmissions using 26-, 52-, 106-, and/or 242-tone allocations, according to various embodiments.

FIG. 6A shows an example 80 MHz transmission with non-contiguous channel bonding, according to one embodiment.

FIG. 6B shows an example 80 MHz transmission with fractional channel bonding, according to one embodiment.

FIG. 6C shows an example 160 MHz transmission with fractional channel bonding, according to one embodiment.

FIG. 7 shows an example 80 MHz transmission including four resource units for two user allocations, according to one embodiment.

FIG. 8 shows an example 80 MHz transmission including two transmissions in frequency division multiplexing (FDM) manner, according to one embodiment.

FIG. 9 shows a flowchart for another example method of communicating over a wireless communication network.

FIG. 10 shows a system that is operable to generate interleaving parameters for orthogonal frequency-division multiple access (OFDMA) tone plans, according to an embodiment.

FIG. 11 shows an example multiple-input-multiple-output (MIMO) system that can be implemented in wireless devices, such as the wireless device of FIG. 10, to transmit and receive wireless communications.

FIG. 12 illustrates two examples of Adjacent Channel Interference (ACI) rejection analysis used to determine a tone plan gap between the system of FIG. 1 and an ACI system.

FIG. 13 illustrates one example of Adjacent Channel Interference (ACI) rejection analysis used to determine a tone plan gap between the system of FIG. 1 and an ACI system.

FIG. 14 illustrates an analysis of a channel bonding scenario for ACI.

FIG. 15 illustrates an adjacent channel simulation for ACI.

FIG. 16 illustrates simulation setup and evaluation criteria for ACI.

FIG. 17 illustrates the impact of transmit/receive filters on the simulation.

FIG. 18 illustrates the simulation performance of modulation and coding scheme (MCS) index 0 at packet error rate (PER)=0.1.

FIG. 19 illustrates the simulation performance of MCS3 at PER=0.1.

FIG. 20 illustrates the simulation performance of MCS6.

FIG. 21 illustrates the simulation performance of MCS8.

FIG. 22 is a summary of the simulation results.

FIG. 23 illustrates results of a simulation with 3 dB and 4 dB backoffs to determine the PA backoff for a specific MCS.

FIG. 24 illustrates packet error rate (PER) v. received signal strength indicator (RSSI) performance.

FIG. 25 is a table of the minimum required adjacent and nonadjacent channel rejection levels.

### DETAILED DESCRIPTION

Various aspects of the novel systems, apparatuses, and methods can be described more fully hereinafter with reference to the accompanying drawings. The teachings of this disclosure can, however, be embodied in many different forms and should not be construed as limited to any specific structure or function presented throughout this disclosure. Rather, these aspects can be provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus can be implemented or a method can be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein can be embodied by one or more elements of a claim.

Although particular aspects can be described herein, many variations and permutations of these aspects fall within the scope of the disclosure. Although some benefits and advantages of the preferred aspects can be mentioned, the scope of the disclosure is not intended to be limited to particular benefits, uses, or objectives. Rather, aspects of the disclosure can be intended to be broadly applicable to different wireless technologies, system configurations, networks, and transmission protocols, some of which can be illustrated by way of example in the figures and in the following description of the preferred aspects. The detailed description and drawings can be merely illustrative of the disclosure rather than limiting, the scope of the disclosure being defined by the appended claims and equivalents thereof.

### Implementing Devices

Wireless network technologies can include various types of wireless local area networks (WLANs). A WLAN can be used to interconnect nearby devices together, employing widely used networking protocols. The various aspects described herein can apply to any communication standard, such as Wi-Fi or, more generally, any member of the IEEE 802.11 family of wireless protocols.

In some aspects, wireless signals can be transmitted according to a high-efficiency 802.11 protocol using orthogonal frequency-division multiplexing (OFDM), direct-sequence spread spectrum (DSSS) communications, a combination of OFDM and DSSS communications, or other schemes.

In some implementations, a WLAN includes various devices which can be the components that access the wireless network. For example, there can be two types of devices: access points (“APs”) and clients (also referred to as stations, or “STAs”). In general, an AP serves as a hub or base station for the WLAN and an STA serves as a user of the WLAN. For example, an STA can be a laptop computer, a personal digital assistant (PDA), a mobile phone, etc. In an example, an STA connects to an AP via a Wi-Fi (e.g., IEEE 802.11 protocol such as 802.11ax) compliant wireless link to obtain general connectivity to the Internet or to other wide area networks. In some implementations an STA can also be used as an AP.

The techniques described herein can be used for various broadband wireless communication systems, including communication systems that can be based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system can utilize sufficiently different directions to concurrently transmit data belonging to multiple user terminals. A TDMA system can allow multiple user terminals to share the same frequency channel by dividing the transmission signal into different time slots, each time slot being assigned to different user terminal. A TDMA system can implement GSM or some other standards known in the art. An OFDMA system utilizes orthogonal frequency division multiplexing (OFDM), which is a modulation technique that partitions the overall system bandwidth into multiple orthogonal sub-carriers. These sub-carriers can also be called tones, bins, etc. With OFDM, each sub-carrier can be independently modulated with data. An OFDM system can implement IEEE 802.11 or some other standards known in the art. An SC-FDMA system can utilize interleaved FDMA (IFDMA) to transmit on sub-carriers that can be distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols can be sent in the frequency domain with OFDM and in the time domain with SC-FDMA. A SC-FDMA system can implement 3GPP-LTE (3rd Generation Partnership Project Long Term Evolution) or other standards.

The teachings herein can be incorporated into (e.g., implemented within or performed by) a variety of wired or wireless apparatuses (e.g., nodes). In some aspects, a wireless node implemented in accordance with the teachings herein can comprise an access point or an access terminal.

An access point (“AP”) can comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A station (“STA”) can also comprise, be implemented as, or known as a user terminal, an access terminal (“AT”), a subscriber station, a subscriber unit, a mobile station, a remote station, a remote terminal, a user agent, a user device, user equipment, or some other terminology. In some implementations an access terminal can comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein can be incorporated into a phone (e.g., a cellular phone or smart phone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

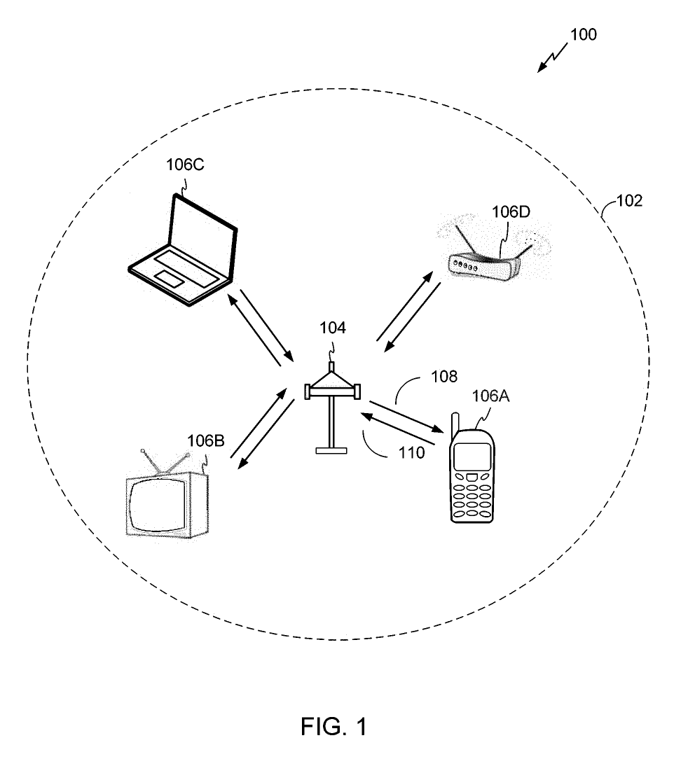

FIG. 1 illustrates an example of a wireless communication system 100 in which aspects of the present disclosure can be employed. The wireless communication system 100 can operate pursuant to a wireless standard, for example the 802.11ax standard. The wireless communication system 100 can include an AP 104, which communicates with STAs 106.

A variety of processes and methods can be used for transmissions in the wireless communication system 100 between the AP 104 and the STAs 106. For example, signals can be transmitted and received between the AP 104 and the STAs 106 in accordance with OFDM/OFDMA techniques. If this is the case, the wireless communication system 100 can be referred to as an OFDM/OFDMA system. Alternatively, signals can be transmitted and received between the AP 104 and the STAs 106 in accordance with CDMA techniques. If this is the case, the wireless communication system 100 can be referred to as a CDMA system.

A communication link that facilitates transmission from the AP 104 to one or more of the STAs 106 can be referred to as a downlink (DL) 108, and a communication link that facilitates transmission from one or more of the STAs 106 to the AP 104 can be referred to as an uplink (UL) 110. Alternatively, a downlink 108 can be referred to as a forward link or a forward channel, and an uplink 110 can be referred to as a reverse link or a reverse channel.

The AP 104 can provide wireless communication coverage in a basic service area (BSA) 102. The AP 104 along with the STAs 106 associated with the AP 104 and that use the AP 104 for communication can be referred to as a basic service set (BSS). It should be noted that the wireless communication system 100 may not have a central AP 104, but rather can function as a peer-to-peer network between the STAs 106. Accordingly, the functions of the AP 104 described herein can alternatively be performed by one or more of the STAs 106.

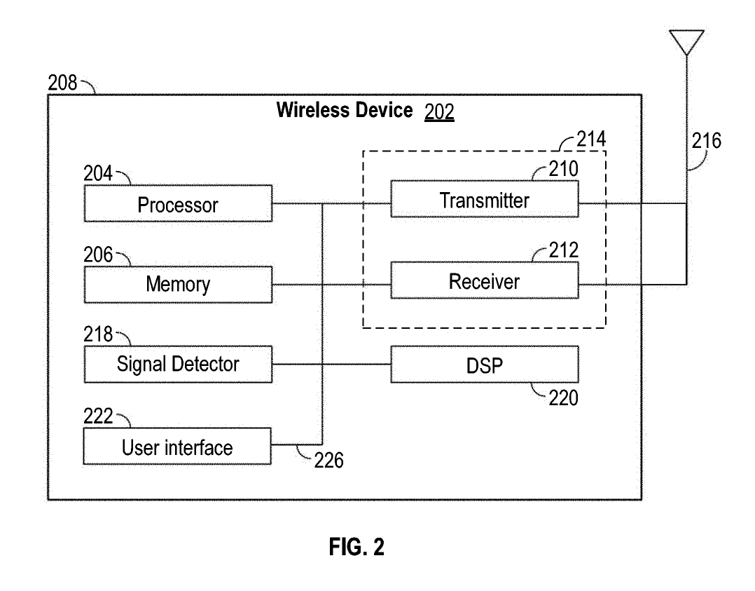

FIG. 2 illustrates various components that can be utilized in a wireless device 202 that can be employed within the wireless communication system 100. The wireless device 202 is an example of a device that can be configured to implement the various methods described herein. For example, the wireless device 202 can comprise the AP 104 or one of the STAs 106.

The wireless device 202 can include a processor 204 which controls operation of the wireless device 202. The processor 204 can also be referred to as a central processing unit (CPU). Memory 206, which can include both read-only memory (ROM) and random access memory (RAM), provides instructions and data to the processor 204. A portion of the memory 206 can also include non-volatile random access memory (NVRAM). The processor 204 typically performs logical and arithmetic operations based on program instructions stored within the memory 206. The instructions in the memory 206 can be executable to implement the methods described herein.

The processor 204 can comprise or be a component of a processing system implemented with one or more processors. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system can also include machine-readable media for storing software. Software shall be construed broadly to mean any type of instructions, whether referred to as software, firmware, middleware, microcode, hardware description language, or otherwise. Instructions can include code (e.g., in source code format, binary code format, executable code format, or any other suitable format of code). The instructions, when executed by the one or more processors, cause the processing system to perform the various functions described herein.

The wireless device 202 can also include a housing 208 that can include a transmitter 210 and a receiver 212 to allow transmission and reception of data between the wireless device 202 and a remote location. The transmitter 210 and receiver 212 can be combined into a transceiver 214. An antenna 216 can be attached to the housing 208 and electrically coupled to the transceiver 214. The wireless device 202 can also include (not shown) multiple transmitters, multiple receivers, multiple transceivers, and/or multiple antennas, which can be utilized during MIMO communications, for example.

The wireless device 202 can also include a signal detector 218 that can be used in an effort to detect and quantify the level of signals received by the transceiver 214. The signal detector 218 can detect such signals as total energy, energy per subcarrier per symbol, power spectral density and other signals. The wireless device 202 can also include a digital signal processor (DSP) 220 for use in processing signals. The DSP 220 can be configured to generate a data unit for transmission. In some aspects, the data unit can comprise a physical layer data unit (PPDU). In some aspects, the PPDU is referred to as a packet.

The wireless device 202 can further comprise a user interface 222 in some aspects. The user interface 222 can comprise a keypad, a microphone, a speaker, and/or a display. The user interface 222 can include any element or component that conveys information to a user of the wireless device 202 and/or receives input from the user.

The various components of the wireless device 202 can be coupled together by a bus system 226. The bus system 226 can include a data bus, for example, as well as a power bus, a control signal bus, and a status signal bus in addition to the data bus. Those of skill in the art will appreciate the components of the wireless device 202 can be coupled together or accept or provide inputs to each other using some other mechanism.

Although a number of separate components can be illustrated in FIG. 2, those of skill in the art will recognize that one or more of the components can be combined or commonly implemented. For example, the processor 204 can be used to implement not only the functionality described above with respect to the processor 204, but also to implement the functionality described above with respect to the signal detector 218 and/or the DSP 220. Further, each of the components illustrated in FIG. 2 can be implemented using a plurality of separate elements.

As discussed above, the wireless device 202 can comprise an AP 104 or an STA 106, and can be used to transmit and/or receive communications. The communications exchanged between devices in a wireless network can include data units which can comprise packets or frames. In some aspects, the data units can include data frames, control frames, and/or management frames. Data frames can be used for transmitting data from an AP and/or a STA to other APs and/or STAs. Control frames can be used together with data frames for performing various operations and for reliably delivering data (e.g., acknowledging receipt of data, polling of APs, area-clearing operations, channel acquisition, carrier-sensing maintenance functions, etc.). Management frames can be used for various supervisory functions (e.g., for joining and departing from wireless networks, etc.).

Certain aspects of the present disclosure support allowing APs 104 to allocate STAs 106 transmissions in optimized ways to improve efficiency. Both high efficiency wireless (HEW) stations, stations utilizing an 802.11 high efficiency protocol (such as 802.11ax), and stations using older or legacy 802.11 protocols (such as 802.11b), can compete or coordinate with each other in accessing a wireless medium. In some embodiments, the high-efficiency 802.11 protocol described herein can allow for HEW and legacy stations to interoperate according to various OFDMA tone plans (which can also be referred to as tone maps). In some embodiments, HEW stations can access the wireless medium in a more efficient manner, such as by using multiple access techniques in OFDMA. Accordingly, in the case of apartment buildings or densely-populated public spaces, APs and/or STAs that use the high-efficiency 802.11 protocol can experience reduced latency and increased network throughput even as the number of active wireless devices increases, thereby improving user experience.

In some embodiments, APs 104 can transmit on a wireless medium according to various DL tone plans for HEW STAs. For example, with respect to FIG. 1, the STAs 106A-106D can be HEW STAs. In some embodiments, the HEW STAs can communicate using a symbol duration four times that of a legacy STA. Accordingly, each symbol which is transmitted may be four times as long in duration. When using a longer symbol duration, each of the individual tones may only require one-quarter as much bandwidth to be transmitted. For example, in various embodiments, a 1× symbol duration can be 3.2 ms and a 4x symbol duration can be 12.8 ms. The AP 104 can transmit messages to the HEW STAs 106A-106D according to one or more tone plans, based on a communication bandwidth. In some aspects, the AP 104 may be configured to transmit to multiple HEW STAs simultaneously, using OFDMA.

### Efficient Tone Plan Design for Multicarrier Allocation

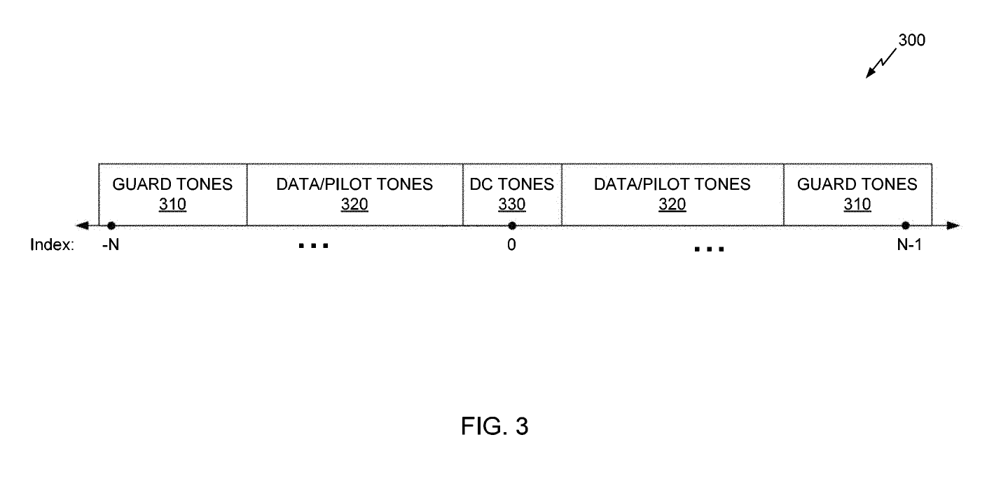

FIG. 3 shows an example 2N-tone plan 300, according to one embodiment. In an embodiment, the tone plan 300 corresponds to OFDM tones, in the frequency domain, generated using a 2N-point fast Fourier transform (FFT). The tone plan 300 includes 2N OFDM tones indexed −N to N−1. The tone plan 300 includes two sets of edge or guard tones 310, two sets of data/pilot tones 320, and a set of direct current (DC) tones 330. In various embodiments, the edge or guard tones 310 and DC tones 330 can be null. In various embodiments, the tone plan 300 includes another suitable number of pilot tones and/or includes pilot tones at other suitable tone locations.

In some aspects, OFDMA tone plans may be provided for transmission using a 4x symbol duration, as compared to various IEEE 802.11 protocols. For example, 4x symbol duration may use a number of symbols which can be each 12.8 ms in duration (whereas symbols in certain other IEEE 802.11 protocols may be 3.2 ms in duration).

In some aspects, the data/pilot tones 320 of a transmission 300 may be divided among any number of different users. For example, the data/pilot tones 320 may be divided among between one and eight users. In order to divide the data/pilot tones 320, an AP 104 or another device may signal to the various devices, indicating which devices may transmit or receive on which tones (of the data/pilot tones 320) in a particular transmission. Accordingly, systems and methods for dividing the data/pilot tones 320 may be desired, and this division may be based upon a tone plan.

A tone plan may be chosen based on a number of different characteristics. For example, it may be beneficial to have a simple tone plan, which can be consistent across most or all bandwidths. For example, an OFDMA transmission may be transmitted over 20, 40, or 80 MHz, and it may be desirable to use a tone plan that can be used for any of these bandwidths. Further, a tone plan may be simple in that it uses a smaller number of building block sizes. For example, a tone plan may contain a unit which may be referred to as resource unit (RU). This unit may be used to assign a particular amount of wireless resources (for example, bandwidth and/or particular tones) to a particular user. For example, one user may be assigned bandwidth as a number of RUs, and the data/pilot tones 320 of a transmission may be broken up into a number of RUs. In various embodiments, RUs can also be referred to as a tone allocation unit (TAUs) or simply allocation units.

In some aspects, it may be beneficial to have a single size of RU. For example, if there were two or more sizes of RU, it may involve more signaling to inform a device of the tones that can be allocated to that device. In contrast, if all tones can be broken up into RUs of consistent size, signaling to a device may simply involve telling a device a number of RUs assigned to that device. Accordingly, using a single RU size may reduce signaling and simplify tone allocation to various devices.

A tone plan may also be chosen based on efficiency. For example, transmissions of different bandwidths (e.g., 20, 40, or 80 MHz) may have different numbers of tones. Thus, it may be beneficial to choose a RU size that leaves fewer tones leftover after the creation of the RUs. For example, if a RU was 100 tones, and if a certain transmission included 199 tones, this may leave 99 tones leftover after creating one RU. Thus, 99 tones may be considered “leftover” tones, and this may be quite inefficient. Accordingly, reducing the number of leftover tones may be beneficial. It may also be beneficial if a tone plan is used which allows for the same tone plan to be used in both UL and DL OFDMA transmissions. Further, it may be beneficial if a tone plan is configured to preserve 20 and 40 MHz boundaries, when needed. For example, it may be desirable to have a tone plan which allows each 20 or 40 MHz portion to be decoded separately from each other, rather than having allocations which can be on the boundary between two different 20 or 40 MHz portions of the bandwidth. For example, it may be beneficial for interference patterns to be aligned with 20 or 40 MHz channels. Further, it may be beneficial to have channel bonding, which may also be known as preamble puncturing, such that when a 20 MHz transmission and a 40 MHz transmission can be transmitted, to create a 20 MHz “hole” in the transmission when transmitted over 80 MHz. This may allow, for example, a legacy packet to be transmitted in this unused portion of the bandwidth. Finally, it may also be advantageous to use a tone plan which provides for fixed pilot tone locations in various different transmissions, such as in different bandwidths.

Generally, a number of different implementations can be presented. For example, certain implementations have been made which include multiple different building blocks, such as two or more different tone units. For example, there may be a basic tone unit (BTU), and a small tone unit (STU), which is smaller than the basic tone unit. Further, the size of the BTU itself may vary based upon the bandwidth of the transmission. In another implementation, resource blocks can be used, rather than tone units. However, in some aspects, it may be beneficial to use a single tone allocation unit RU for all bandwidths of transmissions in OFDMA.

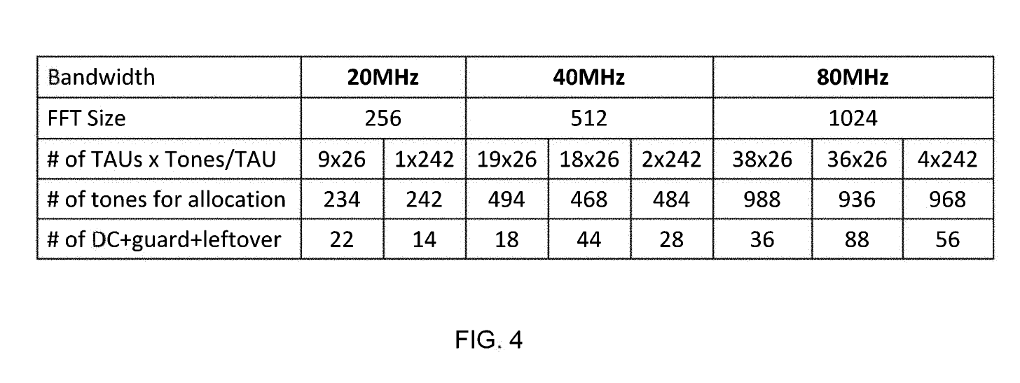

FIG. 4 is an illustration of a 20 MHz, a 40 MHz, and an 80 MHz transmission. As shown in FIG. 4, each transmission can be formed from a combination of one or more 26-tone RUs, or one or more 242-tone RUs. Generally, 26 tones in an IEEE 802.11ax transmission may be transmitted over a bandwidth of 2.03 MHz and 242 tones can be transmitted over a bandwidth of 18.91 MHz. For example, in one implementation, a 20 MHz transmission, having an FFT size of 256, can include 234 allocation tones formed from nine 26-tone RUs, leaving 22 remaining tones for DC tones, edge tones, and other leftover tones. The 234 allocation tones can be used as data and pilot tones. In another implementation, a 20 MHz transmission, having an FFT size of 256, can include 242 allocation tones formed from one 242-tone RU, leaving 14 remaining tones for DC tones, edge tones, and other leftover tones. The 242 allocation tones can be used as data and pilot tones.

As another example, in one implementation, a 40 MHz transmission, having an FFT size of 512, can include 494 allocation tones formed from 19 26-tone RUs, leaving 18 remaining tones for DC tones, edge tones, and other leftover tones. The 494 allocation tones can be used as data and pilot tones. In another implementation, a 40 MHz transmission, having an FFT size of 512, can include 468 allocation tones formed from 18 26-tone RUs, leaving 44 remaining tones for DC tones, edge tones, and other leftover tones. The 468 allocation tones can be used as data and pilot tones. In another implementation, a 40 MHz transmission, having an FFT size of 512, can include 484 allocation tones formed from two 242-tone RUs, leaving 28 remaining tones for DC tones, edge tones, and other leftover tones. The 484 allocation tones can be used as data and pilot tones.

As another example, in one implementation, an 80 MHz transmission, having an FFT size of 1024, can include 988 allocation tones formed from 38 26-tone RUs, leaving 36 remaining tones for DC tones, edge tones, and other leftover tones. The 988 allocation tones can be used as data and pilot tones. In another implementation, an 80 MHz transmission, having an FFT size of 1024, can include 936 allocation tones formed from 36 26-tone RUs, leaving 88 remaining tones for DC tones, edge tones, and other leftover tones. The 936 allocation tones can be used as data and pilot tones. In another implementation, an 80 MHz transmission, having an FFT size of 1024, can include 968 allocation tones formed from four 242-tone RUs, leaving 56 remaining tones for DC tones, edge tones, and other leftover tones. The 968 allocation tones can be used as data and pilot tones.

In various embodiments, the location of the 9th 26 tone block for 20 MHz implementations and the 19^{th} 26-tone block for 40 MHz implementations, can either cross DC or at the edges. In one embodiment, the last 26-tone block can be distributed around DC when the number of DC+leftover tones is greater than 6. In another embodiment, the last 26-tone block can be distributed at the edges when the number guards tones+leftover tones is greater than 12 20 MHz implementations and greater than 18 for 40 MHz implementations. In an embodiment, the allowed allocation unit size can be limited to reduce the TX mode. In an embodiment, the 19^{th} 26-tone RU (or RU) in 40 MHz can go unused if the allocation unit is 2×26. In an embodiment, the 37^{th} and 38^{th} 26-tone blocks in 80 MHz implementations can go unused if the allocation unit is 4×26. In some embodiments, 26-tone blocks can be aligned with 242 tone blocks via leftover tones, as will be discussed with respect to FIG. 8. In various embodiments, 242 allocations will not destroy nearby 26-tone block usage. In various embodiments, leftover tones can be used as extra DC tones, guard tones, or as a common or control channel.

As indicated above, a number of tones may be leftover in certain transmissions. These tones can be used for a number of different uses. For example, these tones may be used as additional DC or edge tones. It may be noted here that some illustrated implementations include transmissions having an odd number of RUs. Because of the odd number of RUs, one of the RUs will cross the DC tones (that is, include tones on each side of the DC tones). In other illustrated implementations, an even number of RUs can be present, so no RU will cross the DC tones.

In some aspects, if a STA is assigned multiple RUs, encoding may be performed across all the assigned RUs. For sub-band OFDMA communications, interleaving may be done in two layers. First, all the bits of a device may be distributed evenly across all RUs assigned to the device. For example, bits 1, 2, 3, . . . N may be assigned to RUs 1, 2, 3, . . . N, and so on. Accordingly, each individual RU may be interleaved within the RU. Thus, only one size of interleaver may be used, that is, the size of a RU. In a distributed OFDMA system, interleaving may or may not be needed. In some aspects, a RU may be chosen, at least in part, based on how many pilot tones may be needed for the RU. For example, a RU of 26 may be beneficial in implementations where only two pilot tones per RU can be used. In implementations where more pilot tones can be used, other RUs may be used. Generally, when considering the size of a RU, there is a trade-off between signaling costs, pilot costs, and leftover tones. For example, when smaller RUs can be used, the number of pilot tones needed (compared to the number of data tones) may increase as a proportion of the total number of tones in a RU. Further, when smaller RUs can be used, signaling may require more data to transmit, since there will be a higher total number of RUs which must be allocated to various devices in an OFDMA transmission. However, as larger RUs can be used, there can be potentially more leftover tones, which may reduce overall throughput for a given bandwidth and be inefficient.

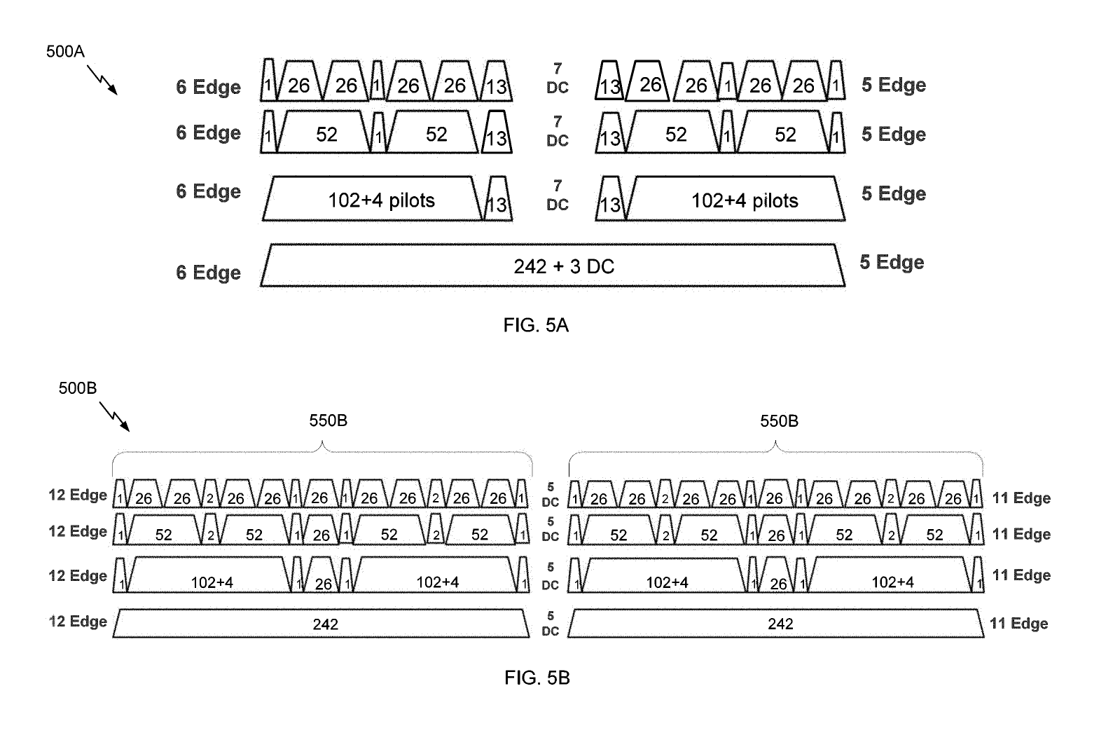

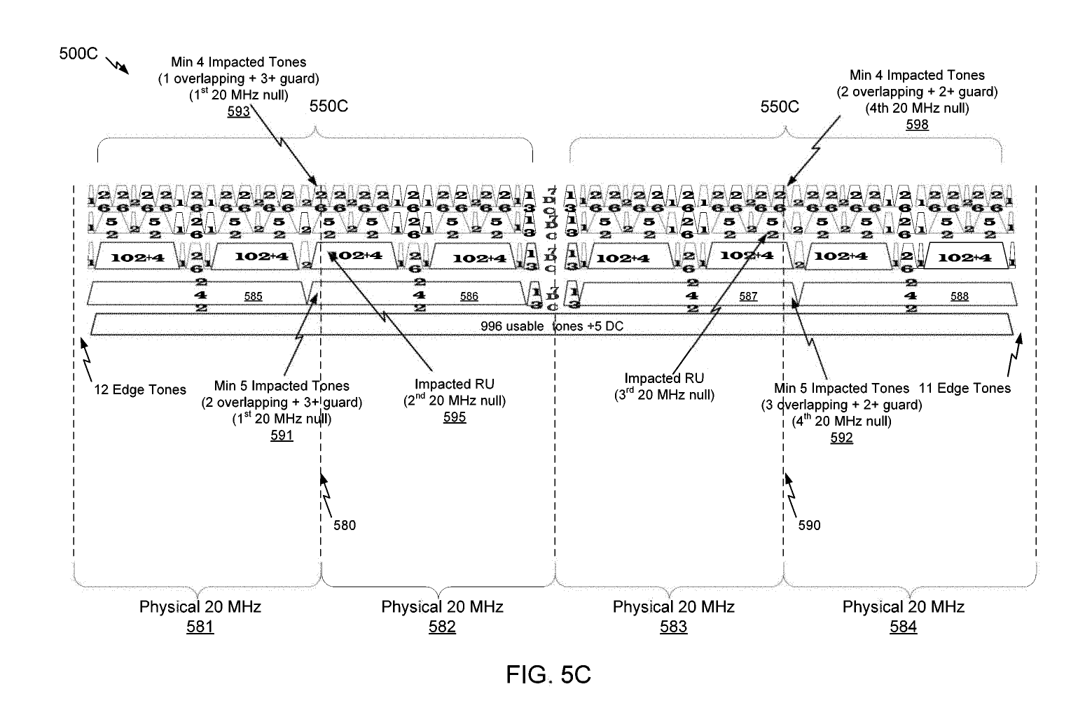

FIGS. 5A-5C show example 20 MHz, 40 MHz, and 80 MHz transmissions using 26-, 52-, 106-, 242-, and/or 996-tone allocations, according to various embodiments. In particular, FIG. 5A shows example 20 MHz transmissions 500A, having 6 left edge tones, 7 DC tones, and 5 right edge tones, and a total of 238 or 242 usable tones. Although FIG. 5A shows four example transmissions 500A using various combinations of 26-, 52-, 106-, and 242-tone blocks, allocations within any given transmission can include multiple tone blocks of different sizes, having different arrangements, in various embodiments.

The first of the illustrated transmissions 500A includes nine 26-tone blocks (with one 26-tone block being divided into two 13-tone portions), 6 left edge tones, 5 right edge tones, 2*A outer leftover tones, 2*B middle leftover tones, 2*C inner leftover tones, 3 DC tones, and 2*D additional DC tones. In the illustrated embodiment, A=1, B=1, C=0, and D=2. As discussed herein, leftover tones can variously be used as edge tones, DC tones, control tones, additional guard tones (for example, in the case of non-contiguous channel bonding), and the like.

The second of the illustrated transmissions 500A includes four 52-tone blocks, one 26-tone block being divided into two 13-tone portions, 6 left edge tones, 5 right edge tones, 2*A outer leftover tones, 2*B middle leftover tones, 2*C inner leftover tones, 3 DC tones, and 2*D additional DC tones. In the illustrated embodiment, A=1, B=1, C=0, and D=2. As discussed herein, leftover tones can variously be used as edge tones, DC tones, control tones, additional guard tones (for example, in the case of non-contiguous channel bonding), and the like.

The third of the illustrated transmissions 500A includes two blocks having 106 tones (102 usable, plus 4 pilot), one 26-tone block being divided into two 13-tone portions, 6 left edge tones, 5 right edge tones, 3 DC tones, and 2*D additional DC tones. In the illustrated embodiment, D=2. In another embodiment, the 106-tone blocks can be replaced with 107-tone blocks including 102 usable tones, plus 5 pilot tones, and the leftover tones adjusted accordingly. As discussed herein, leftover tones can variously be used as edge tones, DC tones, control tones, additional guard tones (for example, in the case of non-contiguous channel bonding), and the like.

The fourth of the illustrated transmissions 500A includes a single 242-tone block having 3 DC tones, 6 left edge tones, 5 right edge tones.

FIG. 5B shows example 40 MHz transmissions 500B, having 12 left edge tones, 5 DC tones, and 11 right edge tones, and a total of 484 usable tones. Although FIG. 5B shows four example transmissions 500B using various combinations of 26-, 52-, 106-, and 242-tone blocks, allocations within any given transmission can include multiple tone blocks of different sizes, having different arrangements, in various embodiments. In the illustrated embodiment, each 40 MHz transmission 500B is a duplicate of two 20 MHz transmissions 550B, which in various embodiments can be the 20 MHz transmissions 500A of FIG. 5A or any other 20 MHz transmission discussed herein.

The first of the illustrated transmissions 500B includes two 20 MHz portions 550B each including nine 26-tone blocks, 2*A outer leftover tones, 2*B middle leftover tones, 2*C inner leftover tones, and 2*D additional inner leftover tones. In the illustrated embodiment, A=1, B=2, C=0, and D=1. As discussed herein, leftover tones can variously be used as edge tones, DC tones, control tones, additional guard tones (for example, in the case of non-contiguous channel bonding), and the like.

The second of the illustrated transmissions 500B includes two 20 MHz portions 550B each including four 52-tone blocks, one 26-tone block, 2*A outer leftover tones, 2*B middle leftover tones, 2*C inner leftover tones, and 2*D additional inner leftover tones. In the illustrated embodiment, A=1, B=2, C=0, and D=1. As discussed herein, leftover tones can variously be used as edge tones, DC tones, control tones, additional guard tones (for example, in the case of non-contiguous channel bonding), and the like.

The third of the illustrated transmissions 500B includes two 20 MHz portions 550B each including two blocks having 106 tones (102 usable, plus 4 pilot), one 26-tone block, 1 additional left edge tone, 1 additional right edge tone, and D leftover tones on each side of the 26-tone block. In the illustrated embodiment D=1. As discussed herein, leftover tones can variously be used as edge tones, DC tones, control tones, additional guard tones (for example, in the case of non-contiguous channel bonding), and the like.

The fourth of the illustrated transmissions 500B includes two 20 MHz portions 550B. Each 20 MHz portion 550B includes a single 242-tone block.

FIG. 5C shows example 80 MHz transmissions 500C having 12 left edge tones, 7 DC tones, and 11 right edge tones, and a total of 994 usable tones for OFDMA, and a total of 996 usable tones for whole bandwidth (BW) allocation with reduced number of DC tones being 5. Although FIG. 5C shows five example transmissions 500C using various combinations of 26-, 52-, 106-, 242-, and 996-tone blocks, allocations within any given transmission can include multiple tone blocks of different sizes, having different arrangements, in various embodiments. In the illustrated embodiment, each 80 MHz transmission 500C is a duplicate of four 20 MHz transmissions 550B, which in various embodiments can be the 20 MHz transmissions 500A of FIG. 5A or any other 20 MHz transmission discussed herein. Additionally or alternatively, each 80 MHz transmission 500C is a duplicate of two 40 MHz transmissions 550C, which in various embodiments can be the 40 MHz transmissions 500B of FIG. 5B or any other 40 MHz transmission discussed herein. In the illustrated embodiment, each 80 MHz transmission 500C further includes an additional 26-tone block divided into two separate 13-tone portions on either side of the 7 DC tones.

The first of the illustrated transmissions 500C includes four 20 MHz portions 550B each including nine 26-tone blocks, 2*A outer leftover tones, 2*B middle leftover tones, 2*C inner leftover tones, and 2*D additional inner leftover tones. In the illustrated embodiment, A=1, B=2, C=0, and D=1. The first of the illustrated transmissions 500C further includes an additional 26-tone block divided into two separate 13-tone portions on either side of the 7 DC tones. As discussed herein, leftover tones can variously be used as edge tones, DC tones, control tones, additional guard tones (for example, in the case of non-contiguous channel bonding), and the like.

The second of the illustrated transmissions 500C includes four 20 MHz portions 550B each including four 52-tone blocks, one 26-tone block, 2*A outer leftover tones, 2*B middle leftover tones, 2*C inner leftover tones, and 2*D additional inner leftover tones. In the illustrated embodiment, A=1, B=2, C=0, and D=1. The second of the illustrated transmissions 500C further includes an additional 26-tone block divided into two separate 13-tone portions on either side of the 7 DC tones. As discussed herein, leftover tones can variously be used as edge tones, DC tones, control tones, additional guard tones (for example, in the case of non-contiguous channel bonding), and the like.

The third of the illustrated transmissions 500C includes four 20 MHz portions 550B each including two blocks having 106 tones (102 usable, plus 4 pilot), one 26-tone block, and D leftover tones on each side of the 106-tone blocks. In the illustrated embodiment, D=1. Thus, in the portions where two 106-tone blocks are adjacent, there are a total of 2 leftover tones between the 106-tone blocks (one for each block). The third of the illustrated transmissions 500C further includes an additional 26-tone block divided into two separate 13-tone portions on either side of the 7 DC tones. As discussed herein, leftover tones can variously be used as edge tones, DC tones, control tones, additional guard tones (for example, in the case of non-contiguous channel bonding), and the like.

The fourth of the illustrated transmissions 500C includes four 20 MHz portions 550B. Each 20 MHz portion 550B includes a single 242-tone block. The fourth of the illustrated transmissions 500C further includes an additional 26-tone block divided into two separate 13-tone portions on either side of the 7 DC tones.

The fifth of the illustrated transmissions 500C includes a single-user tone plan having 5 DC tones in various embodiments. Accordingly, the SU tone plan can include 996 usable tones.

### Non-Contiguous and Fractional Bandwidth

As discussed above, the AP 104 can allocate one or more RUs to each STA 106A-106D. In some embodiments, such allocations can be contiguous within the bandwidth of each transmission. In other embodiments, the allocations can be non-contiguous. In some embodiments, one or more sub-bands (SBs) can be selected for, or determined to contain, interfering wireless transmissions. Such SBs can be referred to as null sub-bands, and can contain one or more unallocated RUs.

For example, null SBs can be chosen based on actual or expected interference from a non-WiFi system (such as, for example, weather radar spectrum) that has fixed locations in known channels. As another example, null SBs can be chosen based on actual or expected interference from one or more legacy 20 MHz overlapping base station service (OBSS) physical channels, in which case the null SBs (and remaining sub-bands for transmission) can be anywhere within the available radio spectrum. As another example, null SBs can be chosen based on actual or expected interference from one or more legacy 40 MHz overlapping base station service (OBSS) physical channels, in which case the null SBs (and remaining sub-bands for transmission) would be at fixed locations according to 80 MHz or 160 MHz channelization embodiments. As another example, null SBs can be chosen based on actual or expected interference from other OFDMA systems, in which case the null SBs may not have 20 MHz boundary. Thus, although null sub-bands are discussed herein in terms of multiples of physical layer (PHY) 20 or 40 MHz channels aligned with AP PPDU BW boundaries, a person of ordinary skill in the art would appreciate that the features described herein can be applied to null SBs and SBs of other sizes and/or alignments.

Although various transmissions can be referred to herein as sub-bands, a person having ordinary skill in the art will appreciate, that in some embodiments, sub-bands can be referred to as bands or channels. As used herein, “BSS BW” can refer to bandwidth setup for use in a particular BSS, for example an entire channel. “PPDU BW” can refer to bandwidth of a particular PPDU being transmitted. For example, the AP 104 (FIG. 1) can set up a BSS having 80 MHz BSS BW. Within the 80 MHz BSS BW, STAs 106A-106D can transmit on 20+40 MHz allocations due to interference in the null SB of the secondary channel. Thus, for FDMA packets, PPDU BW of a first packet can be 20 MHz, and PPDU BW of a second packet can be 40 MHz. For OFDMA packets, PPDU BW of a single packet can be 20+40 MHz.

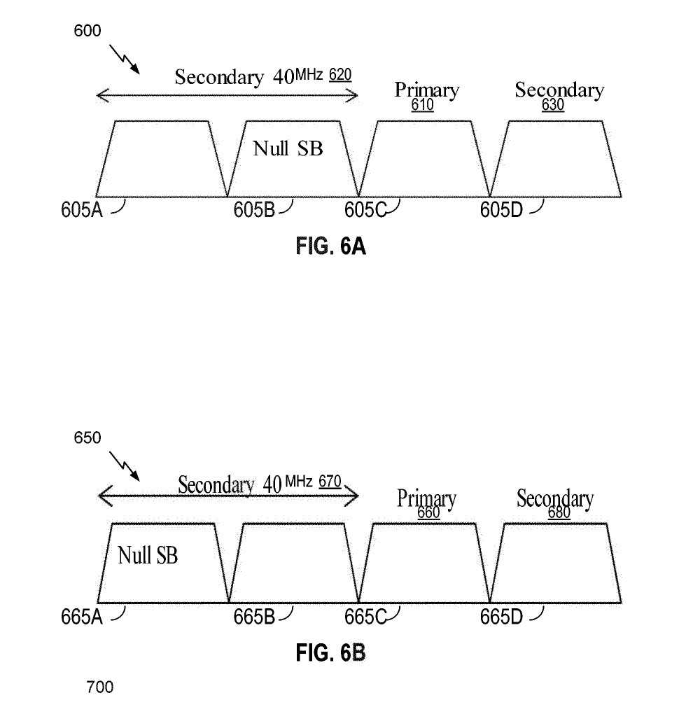

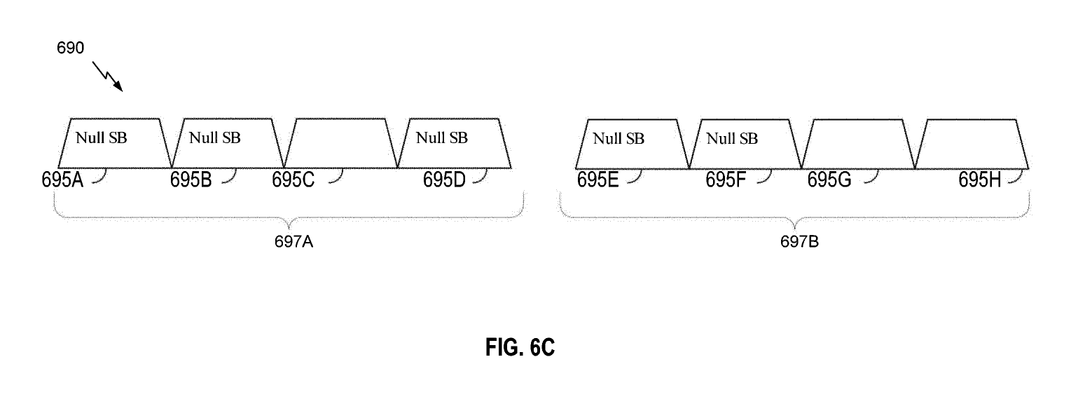

FIG. 6A shows an example 80 MHz transmission 600 with non-contiguous channel bonding. The transmission 600 includes four 20 MHz sub-bands 605A-605D, according to one embodiment. Although FIG. 6A shows one example 80 MHz transmission 600, other transmission sizes can be used, sub-bands can be added, omitted, rearranged, reallocated, or resized in various embodiments. For example, in various embodiments, the teachings of transmission 600 can be applied to any of the tone plans or transmission discussed herein.

As shown in FIG. 6A, the transmission 600 includes a primary channel 610, and secondary channels 620 and 630. The secondary channel 620 includes a null sub-band 605B, which is not allocated for transmission. Accordingly, non-contiguous sub-bands 605A, 605C, and 605D can be used for transmission. In some embodiments, the transmission 600 can be referred to as a 20+40 MHz transmission, wherein the sub-band 605A can include 20 MHz, and the sub-bands 605C-605D each comprise 20 MHz totaling 40 MHz. In some embodiments, non-contiguous sub-bands 605A, 605C, and 605D can be allocated to the same STA, for example the STA 106A.

In other embodiments, sub-bands can be contiguous, but can comprise only a strict subset of entire channel bandwidth. Such transmissions can be referred to as fractional transmissions or fractional allocations. One such example fractional transmission is shown in FIG. 6B.

FIG. 6B shows an example 80 MHz transmission 600 with fractional channel bonding. The transmission 650 includes four 20 MHz sub-bands 655A-655D, according to one embodiment. Although FIG. 6B shows one example 80 MHz transmission 650, other transmission sizes can be used, sub-bands can be added, omitted, rearranged, reallocated, or resized in various embodiments. For example, in various embodiments, the teachings of transmission 650 can be applied to any of the tone plans or transmission discussed herein.

As shown in FIG. 6B, the transmission 650 includes a primary channel 660, and secondary channels 670 and 680. The secondary channel 670 includes a null sub-band 655A, which is not allocated for transmission. Accordingly, contiguous sub-bands 655B, 655C, and 655D can be used for transmission. In some embodiments, the transmission 650 can be referred to as a 60 MHz transmission, wherein the sub-bands 605B-605D each comprise 20 MHz totaling 60 MHz. Similar fractional and/or non-contiguous allocations can be applied to other channel bandwidths, for example as shown in FIG. 6C.

FIG. 6C shows an example 160 MHz transmission 690 with fractional channel bonding. The illustrated transmission 690 includes two 80 MHz segments 697A-697B, each including four 20 MHz sub-bands 695A-695D and 695E-695H, respectively. Although FIG. 6C shows one example 80+80 MHz transmission 690, other transmission sizes can be used, sub-bands can be added, omitted, rearranged, reallocated, or resized in various embodiments. For example, in various embodiments, the teachings of transmission 690 can be applied to any of the tone plans or transmission discussed herein.

As shown in FIG. 6C, the transmission 690 includes null sub-bands 695A, 695B, 695D, 695E, and 695F, which can be not allocated for transmission. Accordingly, sub-band 695C and contiguous sub-bands 695G-695H can be used for transmission. In some embodiments, the transmission 690 can be referred to as a 20+40 MHz transmission, wherein the sub-band 695C is 20 MHz, and sub-bands 695G-695H each include 20 MHz totaling 40 MHz.

### Determination of Impacted RUs

As discussed above with respect to FIGS. 6A-6C fractional or non-contiguous channel allocation is available in a variety of BSS BWs including 80, 160, and 80+80 MHz. As discussed above, the entire PPDU BW tone plan may not be suitable in the channel bonding cases discussed above. For example, null SBs may not be aligned to physical 20 MHz boundaries and RU boundaries in unmodified tone plans can result in insufficient inter-channel interference mitigation. The channel bonding applications discussed herein have heretofore been unexploited in WiFi systems, and thus the problem of mitigating impacted tones unexplored. Accordingly, new tone plans and treatments are needed for channel bonding embodiments.

Referring back to FIG. 5C, a plurality of physical 20 MHz SBs 581-584 and associated boundaries are shown. Although the illustrated transmission 500C is an 80 MHz transmission, the teachings herein can also be applied to 40 MHz transmissions, 160 MHz transmissions, and 80+80 MHz transmissions (which, for example, can include two duplicated 80 MHz transmissions).

As shown in FIG. 5C, the first 242-tone block 585 is shifted 2 tones away from a boundary 580 of a first physical 20 MHz SB 581. The second 242-tone block 586 includes 2 tones crossing the 20 MHz boundary 580. Accordingly, in embodiments where the first physical 20 MHz SB 581 is a null SB and 3 additional left guard tones are specified, the 2 overlapping tones, plus 3 left guard tones equals 5 total tones 591, which can be referred to as impacted tones. Such impacted tones can overlap with a null SB, or a guard band thereof. Similarly, because the second 242-tone block 586 includes impacted tones, it can be referred to as an impacted RU. Moreover, where the second 20 MHz SB 582 is a null SB, the entire second 242-tone block 586 can be impacted (240 overlapping tones, plus 2 right edge tones).

The 7 DC tones can be split into 3+4 tones across a 20 MHz boundary and can serve as guard bands to the 20 MHz boundary in some embodiments. The third 242-tone block 587 includes 3 tones crossing a 20 MHz boundary 590, so assuming 2 right guard tones there are a total of 5 impacted tones 592 when the fourth physical 20 MHz SB 584 is null. The fourth 242-tone block 588 is shifted 3 tones away from the 20 MHz boundary 590. Although the foregoing description refers to the 242-tone blocks 585-589, the 26-, 56-, and 106-tone blocks can be impacted in the same way (and different tones of the same RU can be impacted with respect to different PHY 20 MHz SBs). For example, the 106-tone block 595 (and others) can include at least 4 impacted tones 593 with respect to the first physical 20 MHz SB 581 and all tones can be impacted with respect to the second physical 20 MHz SB 582, and so forth. Moreover, in embodiments where the number of guard tones is lower or higher, greater or fewer total tones can be impacted, respectively.

In various embodiments, the AP 104 can provide a plurality of channel bonding scenarios. For example, in the illustrated 80 MHz BSS BW, the first through fourth physical 20 MHz SBs 581-584 can be referred to herein as [1], [2], [3], and [4], respectively. Similarly, [1+2], [2+3], [3+4] can be used herein to represent physical 40 MHz SBs (for example, combining the first physical 20 MHz SB 581 with the second physical 20 MHz SB 582 and so forth). Likewise, for 160 and 80+80 MHz BSS BWs first through eight 20 MHz SBs (not shown) can be referred to herein as [1], [2], [3], [4], [5], [6], [7], [8], respectively. Similarly, [1+2], [2+3], [3+4], [5+6], [6+7], [7+8] can be used herein to represent physical 40 MHz SBs (for example, combining the first physical 20 MHz SB 581 with the second physical 20 MHz SB 582 and so forth), and [1+2+3+4], [5+6+7+8] can be used herein to represent physical 80 MHz SBs (for example, combining the first through fourth physical 20 MHz SBs 581-584 and so forth).

Accordingly, the following examples of channel bonding in an 80 MHz BSS BW can be employed. When bonding two 20 MHz channels, [1]+[3], [1]+[4], and [2]+[4]. When bonding a 20 MHz channel with a 40 MHz channel, [1+2]+[3] (or [1]+[2+3]), [1+2]+[4], [2]+[3+4] (or [2+3]+[4]), and [1]+[3+4] (noting that 20+20+20 MHz is equivalent to 20+40 MHz).

Similarly, the following examples of channel bonding in an 80+80 MHz BSS BW can be employed. When bonding two 20 MHz channels, [1]+[5], [1]+[6], [1]+[7], [1]+[8], [2]+[6], [2]+[7], [2]+[8], [3]+[7], [3]+[8], and [4]+[8]. When bonding a 20 MHz channel with a 40 MHz channel, [1+2]+[5], [1+2]+[6], [1+2]+[7], [1+2]+[8], [2+3]+[6], [2+3]+[7], [2+3]+[8], [3+4]+[7], [3+4]+[8], [1]+[5+6], [2]+[5+6], [1]+[6+7], [2]+[6+7], [3]+[6+7], [1]+[7+8], [2]+[7+8], [3]+[7+8], and [4]+[7+8]. Various additional 20+20+20 MHz examples are discussed below with respect to 160 MHz BSS BW that can also apply to 80+80 MHz BSS BW. When bonding a 20 MHz channel with an 80 MHz channel, [1+2+3+4]+[5], [1+2+3+4]+[6], [1+2+3+4]+[7], [1+2+3+4]+[8], [1]+[5+6+7+8], [2]+[5+6+7+8], [3]+[5+6+7+8], and [4]+[5+6+7+8]. Various additional 20+40 MHz examples are discussed below with respect to 160 MHz BSS BW that can also apply to 80+80 MHz BSS BW. When bonding a 40 MHz channel with another 40 MHz channel, [1+2]+[5+6], [1+2]+[6+7], [1+2]+[7+8], [2+3]+[5+6], [2+3]+[6+7], [2+3]+[7+8], [3+4]+[6+7], and [3+4]+[7+8]. Various additional 20+20+40 MHz examples are discussed below with respect to 160 MHz BSS BW that can also apply to 80+80 MHz BSS BW. When bonding a 40 MHz channel with an 80 MHz channel, [1+2+3+4]+[5+6], [1+2+3+4]+[6+7], [1+2+3+4]+[7+8], [1+2]+[5+6+7+8], [2+3]+[5+6+7+8], and [3+4]+[5+6+7+8]. Various additional 20+20+40+40 MHz examples are discussed below with respect to 160 MHz BSS BW that can also apply to 80+80 MHz BSS BW.

Similarly, the following examples of channel bonding in a 160 MHz BSS BW can be employed (in addition to those discussed above with respect to 80+80 MHz BSS BW). When bonding a 20 MHz channel with a 40 MHz channel (equivalent to additional 20+20+20 MHz cases), [1]+[4+5], and [4+5]+[8]. When bonding a 20 MHz channel with an 80 MHz channel (equivalent to additional 20+40+40 MHz cases), [2+3+4+5]+[6], [2+3+4+5]+[7], [2+3+4+5]+[8], [1]+[3+4+5+6], [3+4+5+6]+[7], [3+4+5+6]+[8], [1]+[4+5+6+7], and [2]+[4+5+6+7]. When bonding a 40 MHz channel with a 40 MHz channel (equivalent to additional 20+20+40 MHz cases), [1+2]+[4+5], and [4+5]+[7+8]. When bonding a 40 MHz channel with an 80 MHz channel (equivalent to additional 20+20+40+40 MHz cases) [2+3+4+5]+[6+7], [2+3+4+5]+[7+8], and [1+2]+[4+5+6+7].

Adjacent Channel Interference (ACI) Rejection Analysis with Channel Bonding

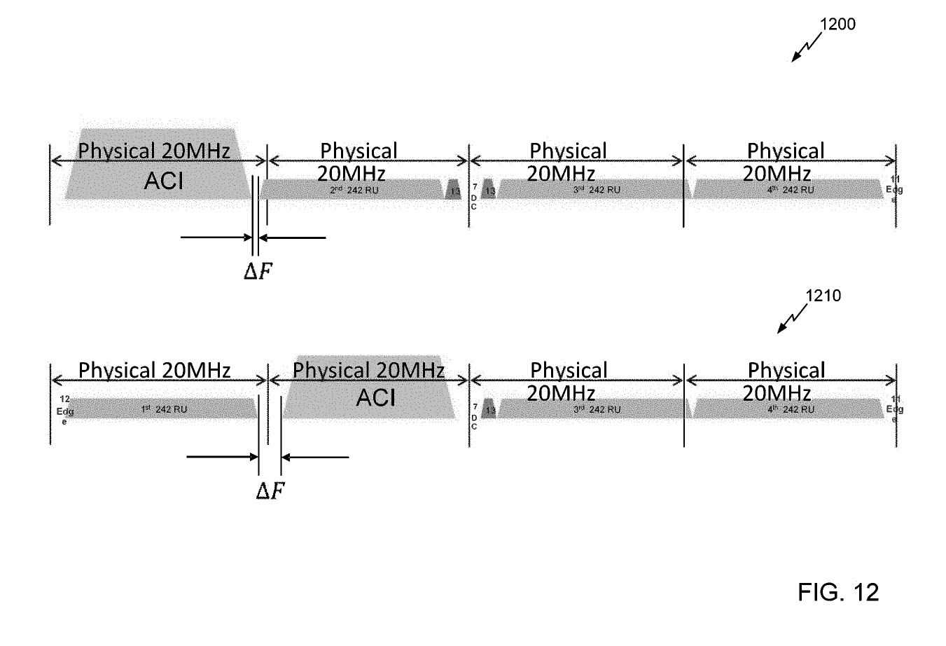

FIGS. 12-25 show ACI rejection analysis used to determine a tone plan gap between the system herein and an ACI system (e.g., the frequency spacing due to number of unpopulated tones between two tone plans) as ΔF=aΔ_{F4x}, where Δ_{F4x} is the tone spacing defined in IEEE 802.11ax.

FIG. 12 illustrates two examples where ACI may occur. Example 1200 is an implementation where the null subband is due to a 20 MHz transmission in the 1st physical 20 MHz. Example 1210 is an implementation where the null subband is due to a 20 MHz transmission in the 2nd physical 20 MHz. ACI could be for an 11a or 11ax 20 MHz signal. For example, 11a signal has tone spacing Δ_{F1x}=312.5 kHz. For example, 11ax signal has tone spacing Δ_{F4x}=78.125 kHz.

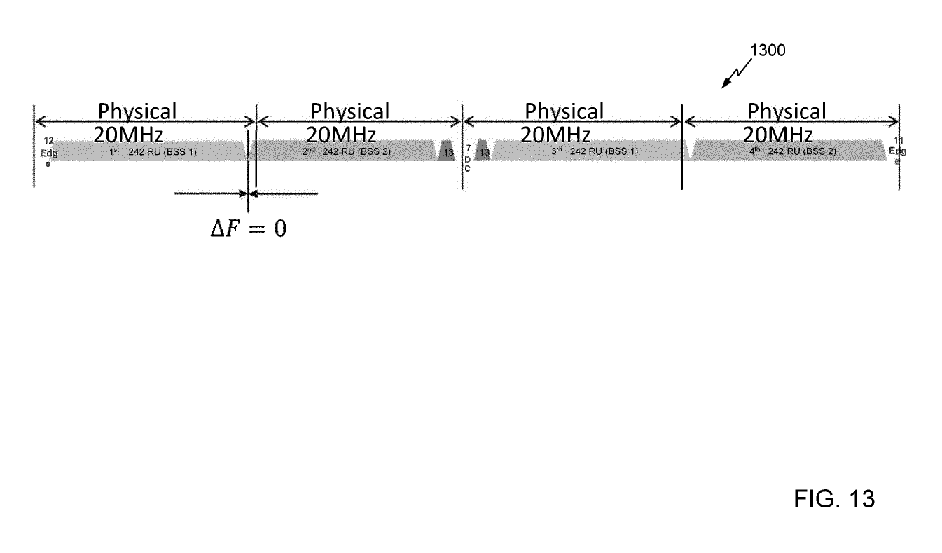

In FIG. 13, example 1300 of ACI is illustrated. Example 1300 is an implementation where two 11ax systems BSS 1 and BSS 2 have 80 MHz BSS BW and are using the same physical 80 MHz. Each is transmitting on only part of the BSS BW. This may happen when the 2nd and 4th physical 20 MHz are occupied (say, BSS 0), BSS 1 starts transmission using the 1st and 3rd physical 20 MHz. Then, BSS 0 stops transmission. BSS 2 starts transmission using the 2nd and 4th physical 20 MHz. There is 0 gap between adjacent 242-tone RUs between the two 11ax systems.

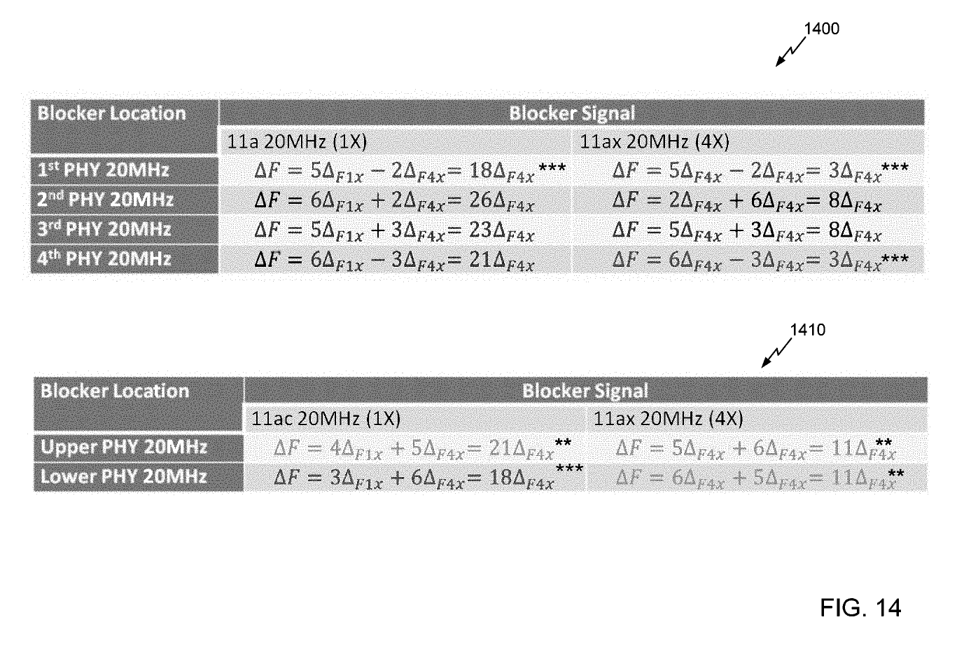

FIG. 14 illustrates an analysis of a channel bonding scenario. When one 20 MHz null subband is a different physical 20 MHz, the closest tone plan gaps to the nearest 242-tone RU are listed in table 1400 (smallest gaps=***). A prior blocker performance evaluation is listed in table 1410 and indicated that the below “Upper PHY 20 MHz” had <3 dB shift at PER=0.1 (simulated=**).

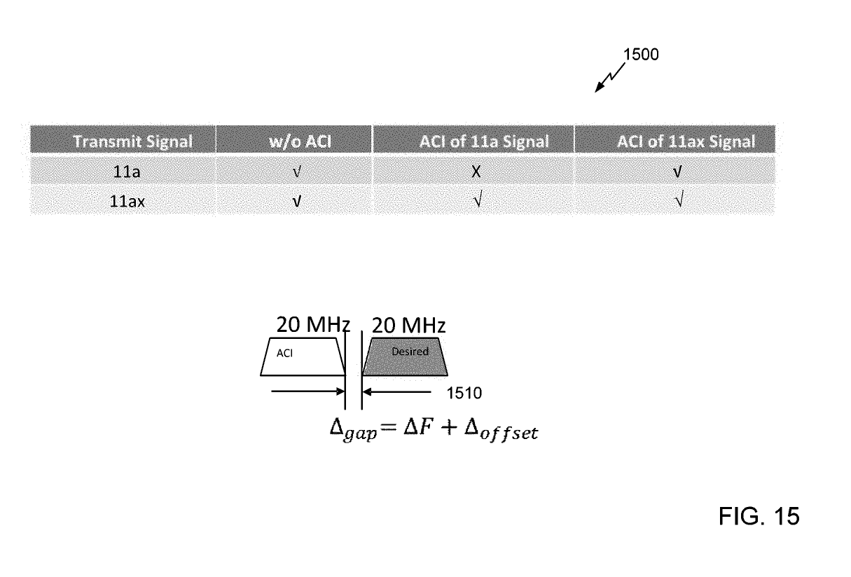

FIG. 15 illustrates an adjacent channel simulation. Between 11a (or 11ac) and 11ax: ΔF=18Δ_{F4x}. Between 11ax and 11ax: ΔF=0, ΔF=3Δ_{F4x} and ΔF=8Δ_{F4x}. Five ACI scenarios were simulated as indicated by the check marks in table 1500. In simulation, the actual frequency gap 1510 (at edge) between the desired system and ACI is given as Δ_{gap}=4F+Δ_{offset}, where: ΔF=tone plan frequency gap given by scenario (assuming synchronized in frequency) and Δ_{offset}=the frequency offset between two unsynchronized systems, given by a random frequency shift uniformly distributed in [−300 kHz,+300 kHz] as shown in FIG. 15.

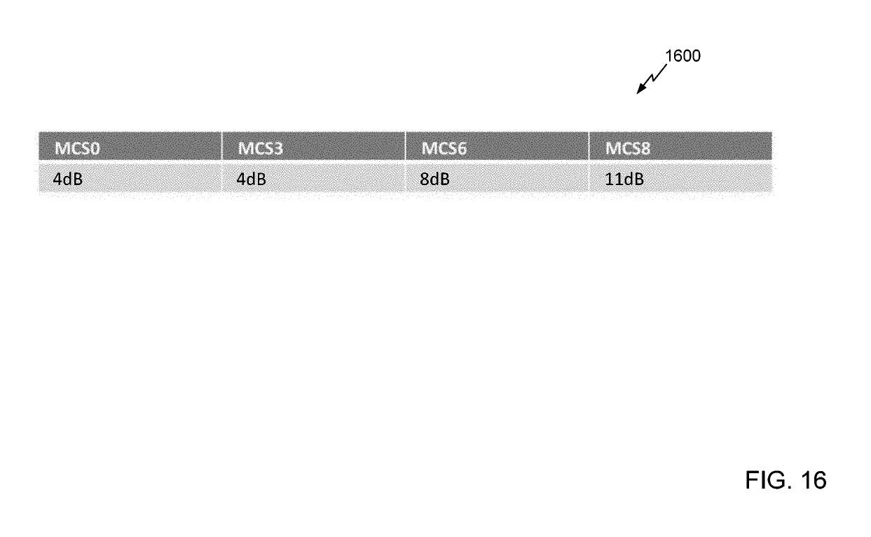

FIG. 16 illustrates exemplary simulation setup and evaluation criteria. For a 20 MHz system with no impairment the following was employed. For 11a signal=11a 64FFT tone plan (1 DC, 11 guards, 48 data & 4 pilots). For 11ax signal=11ax 1024FFT tone plan (page 2). Power Amplifier (PA): Rapp's model with P=3, and backoff value depending on MCS as illustrated in table 1600. Additive white Gaussian noise (AWGN) channel was employed. For the simulations, if not specified, the desired and ACI signals share the same MCS.

MCS0: If ACI exists, ACI has power of 16 dB above transmit signal.

MCS3: If ACI exists, ACI has power of 8 dB above transmit signal.

MCS6: If ACI exists, ACI has power of −1 dB above transmit signal.

MCS8: If ACI exists, ACI has power of −7 dB above transmit signal.

For the simulations, the packet size of 1000 bytes and 1000 packets per SNR point. The evaluation criterion was blocker performance satisfaction (<3 dB shift at PER=0.1) and flooring issue in PER.

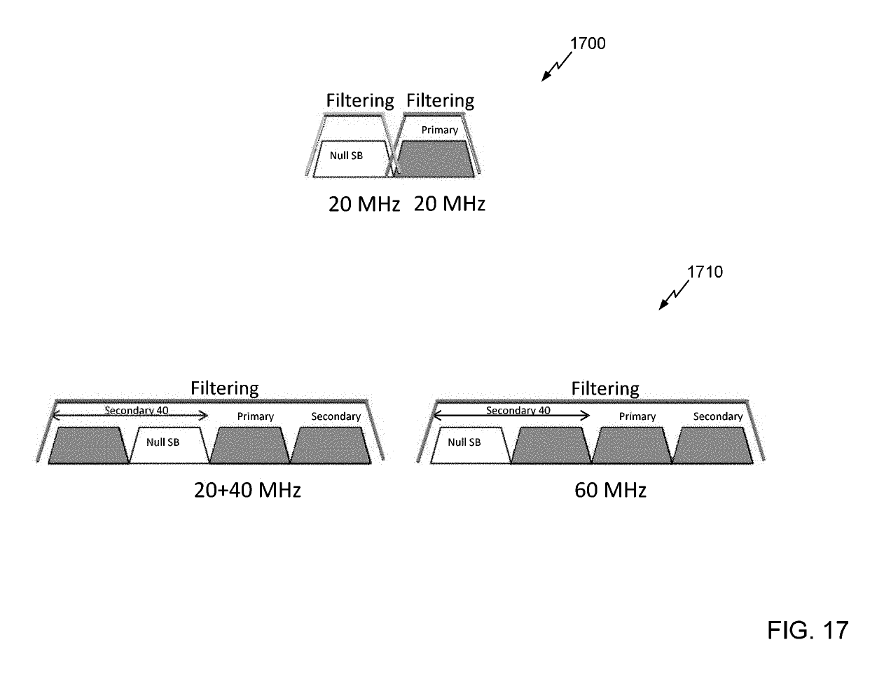

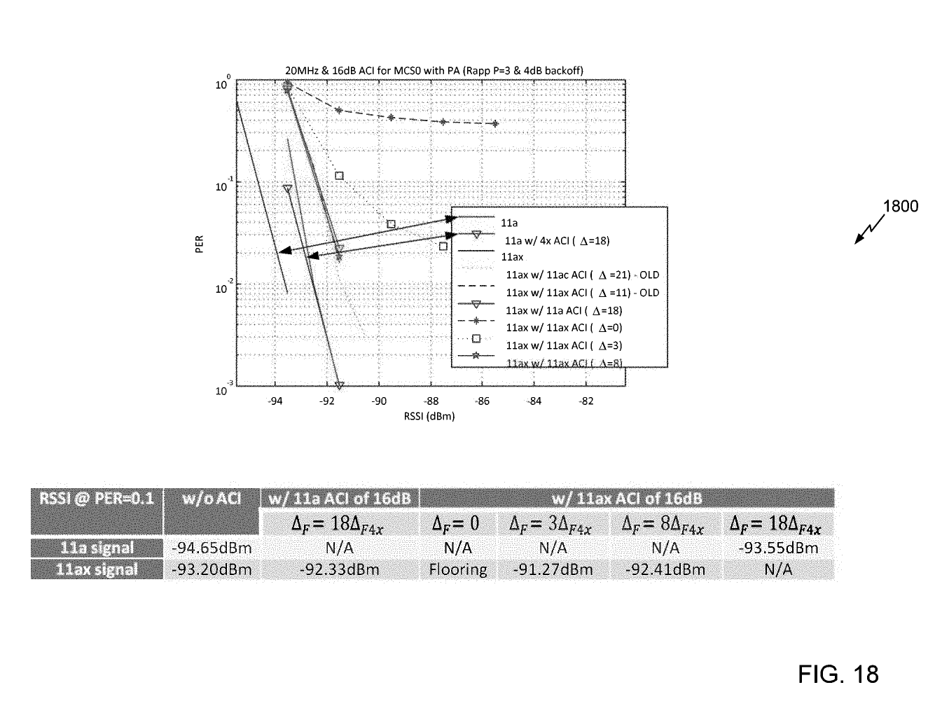

FIG. 17 illustrates the impact of transmit/receive filters on the simulation. A transmit finite impulse response filter (TxFIR) is used for pulse shaping to meet mask and reduce ACI. A receive finite impulse response filter (RxFIR) is used to reject ACI. For case 1700 (current simulation, better scenario): The 20 MHz system in null subband has TxFIR/RxFIR. The 242-tone RU(s) adjacent to the null subband also has own TxFIR/RxFIR fitting a 20 MHz channel bandwidth. Case 1710: If TxFIR/RxFIR are applied to the 80 MHz channel bandwidth, and could not mitigate null subband's ACI which is in their in-band.

FIG. 18 illustrates the simulation performance 1800 of MCS0 at PER=0.1. The frequency gap ΔF=18Δ_{F4x} between 11a and 11ax signals is sufficient. This is ˜1.1 dB shift for 11a signal and <1 dB shift for 11ax signal. Between 11ax signals the frequency gaps ΔF=8Δ_{F4x} and ΔF=3Δ_{F4x} bring <1 dB and <2 dB shift, respectively. With ΔF=3Δ_{F4x}, there is a flooring around PER=0.02. With Δ_{F}=0, there is a flooring way above PER=0.1. Except for Δ_{F}=3Δ_{F4x} and Δ_{F}=0, all ACI performance are close to old blocker performance.

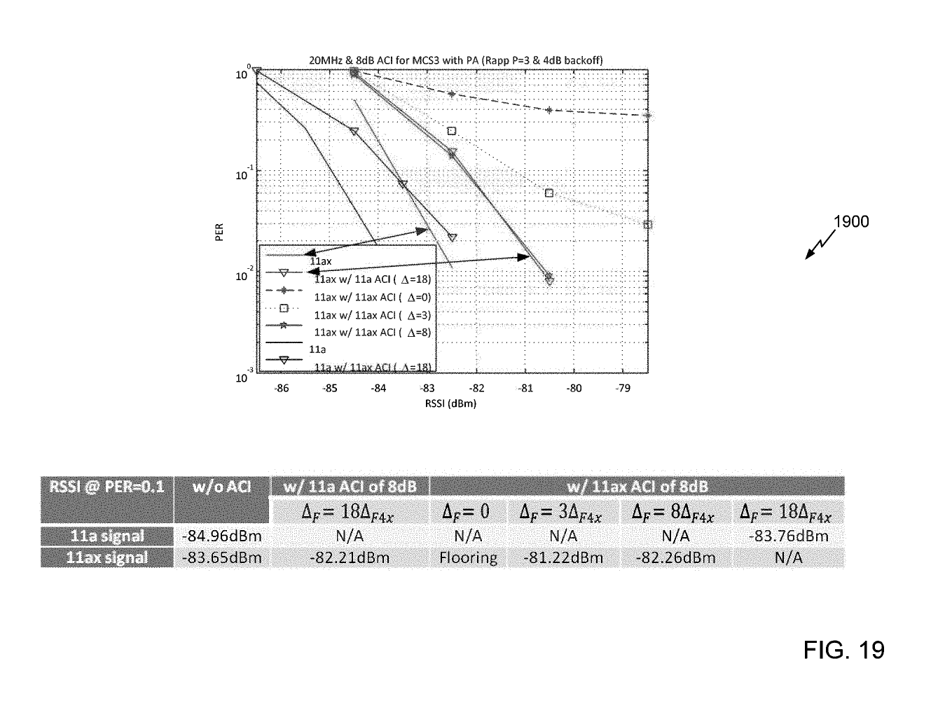

FIG. 19 illustrates the simulation performance 1900 of MCS3 at PER=0.1. The frequency gap Δ_{F}=18Δ_{F4x} between 11a and 11ax signals is sufficient since there is ˜1.20 dB shift for 11a signal and a ˜1.44 dB shift for 11ax signal. Between 11ax signals the frequency gaps ΔF=8Δ_{F4x} and ΔF=3Δ_{F4x} bring ˜1.39 dB and ˜2.43 dB shift, respectively. With ΔF=3Δ_{F4x}, the PER slope change shows that there may be a flooring around PER=0.02. With Δ_{F}=0, there is a flooring way above PER=0.1.

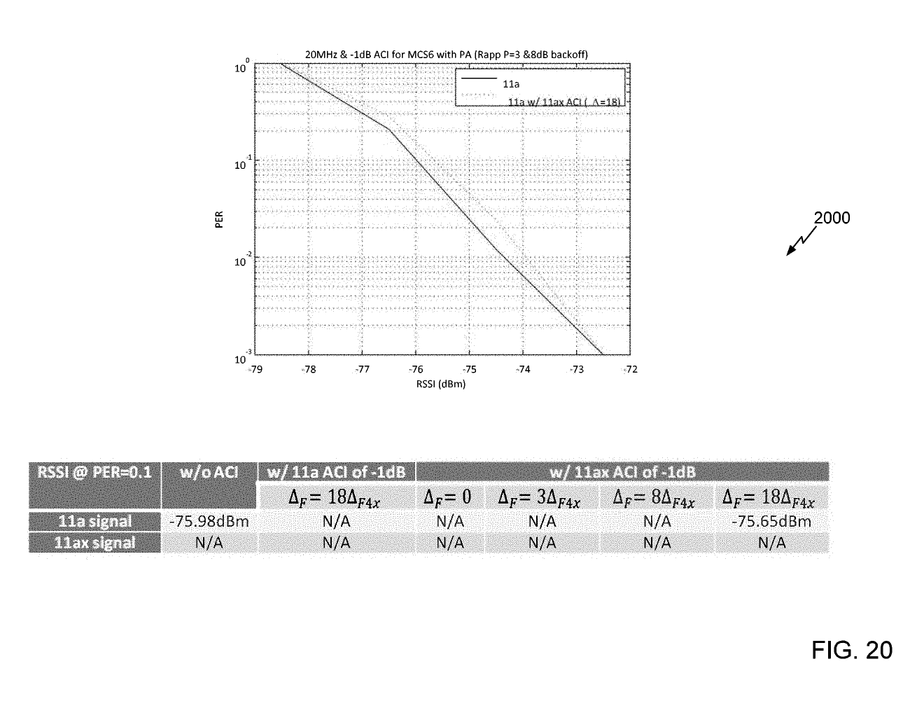

FIG. 20 illustrates the simulation performance 2000 of MCS6. An 11a signal was evaluated without ACI or with 11ax ACI of MCS8. At PER=0.1, the SNR shifts <0.5 dB. The frequency gap ΔF=18Δ_{F4x} between 11a and 11ax signals is sufficient since it brings a ˜0.33 dB shift for the 11a signal.

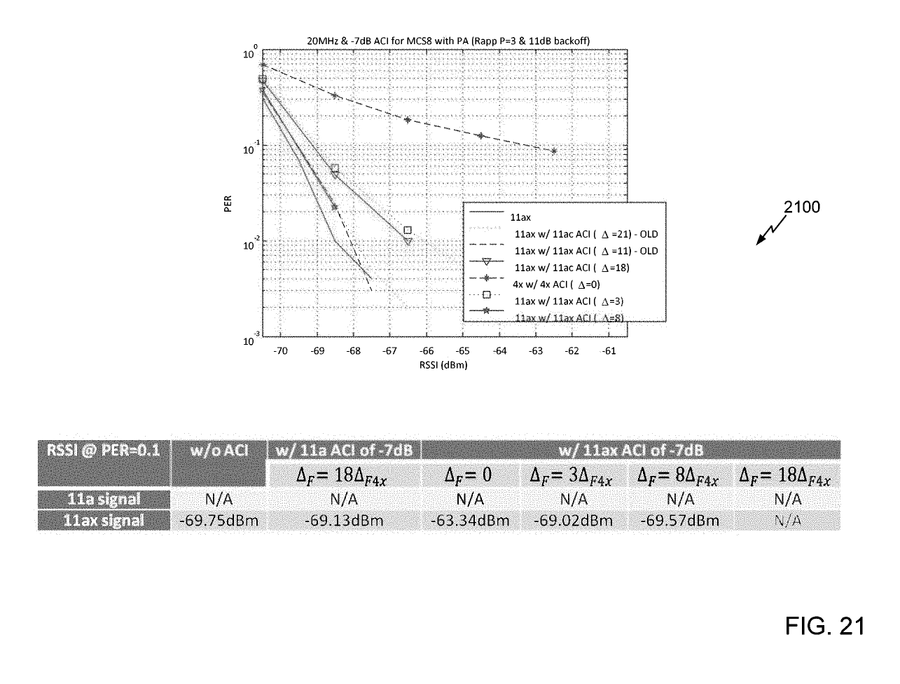

FIG. 21 illustrates the simulation performance 2100 of MCS8. An 11ax signal was evaluated without ACI or with 11ac/11ax ACI of MCS8. At PER=0.1, the frequency gap ΔF=18Δ_{F4x} between 11ac and 11ax signals is sufficient since it brings a ˜0.62 dB shift for 11ax signal. Between 11ax signals both frequency gaps Δ_{F}=8Δ_{F4x} and Δ_{F}=3Δ_{F4x} bring <1 dB shift. The ACI performance of Δ_{F}=8Δ_{F4x} and that of Δ_{F}=11Δ_{F4x} are very close. The frequency gap Δ_{F}=0 brings ˜6.41 dB shift and probably exhibit a flooring around PER=0.1.

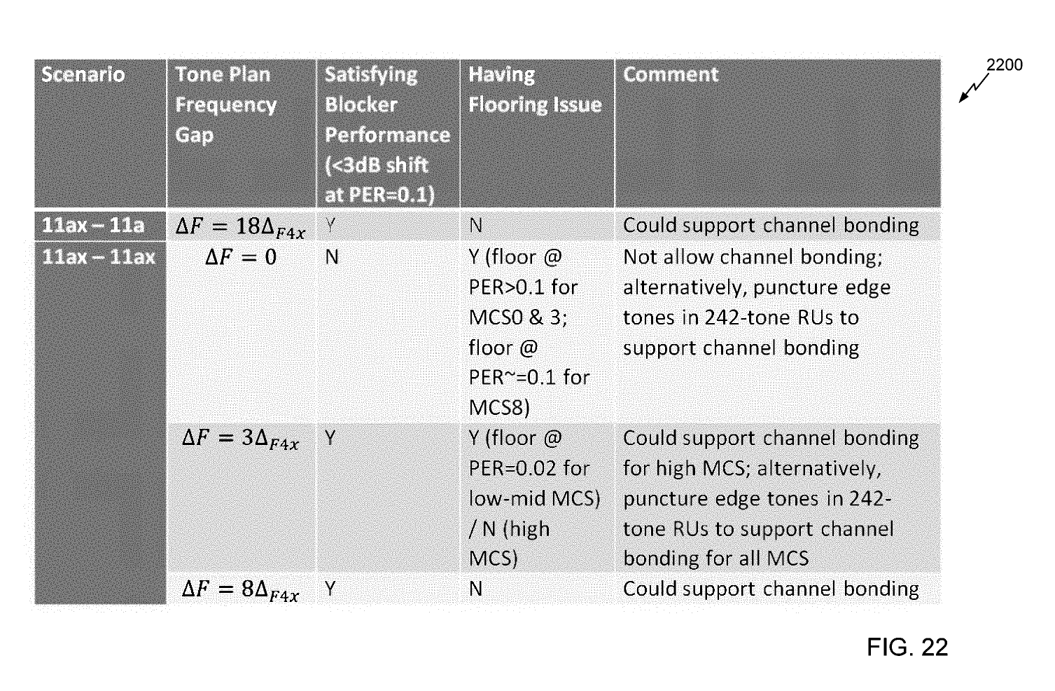

FIG. 22 is a summary 2200 of the simulation results. As illustrated and discussed herein, when ΔF≧8Δ_{F4x}, the performance of a blocker defined in IEEE 802.11ac (<3 dB shift at PER=10%) is satisfied and there is no flooring issue. Unexpectedly, in some embodiments a minimum of 8 tones (ΔF=8Δ_{F4x}) are used as a tone plan gap for a 242-tone RU. Because RUs of smaller sizes at the edge may have worse ACI rejection capability a larger tone plan gap can be applied.

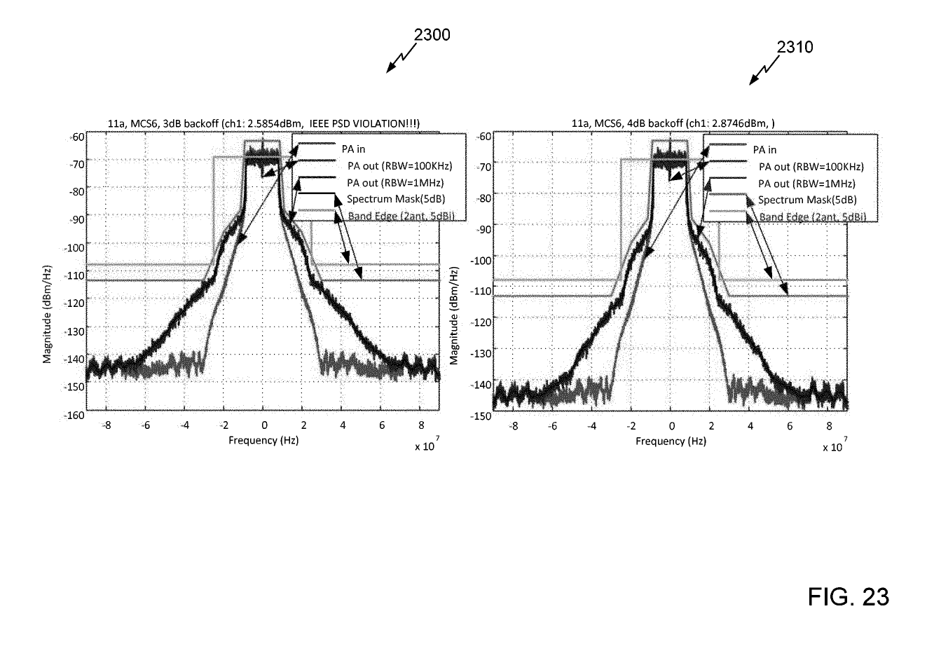

FIG. 23 illustrates results of a simulation with 3 dB 2300 and 4 dB 2310 backoffs to determine the PA backoff for a specific MCS. Given the knee parameter p in the Rapp's model, there are two criteria to find the PA backoff for a specific MCS. One is to find the minimum backoff that meets the IEEE and FCC masks and the other is to find the minimum backoff whose PER performance has within 1 dB shift at 1% PER from the case without PA. For an 11a signal at MCS6, even a 4 dB backoff could meet all masks.

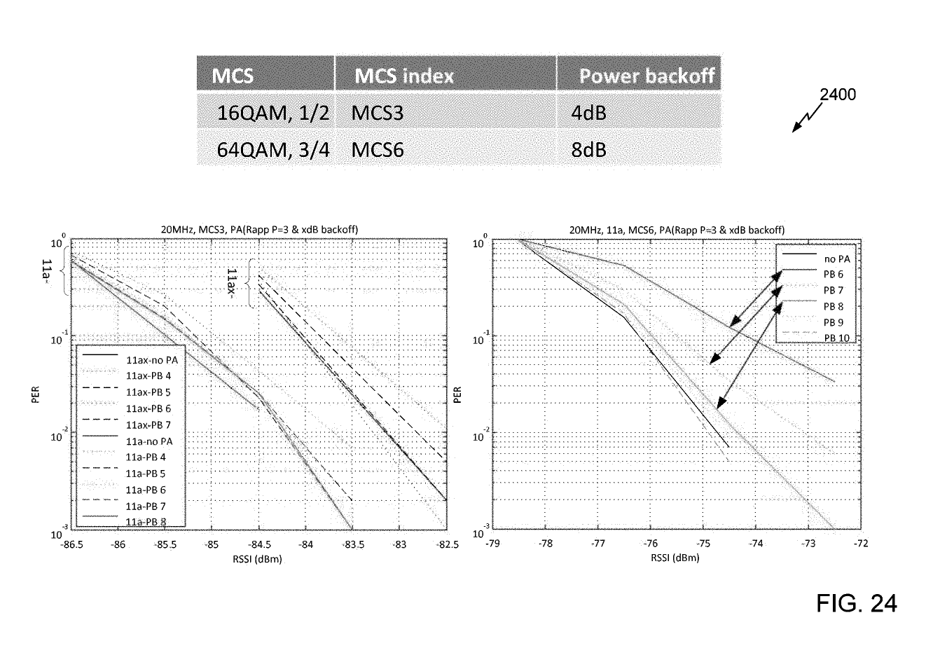

From the PER performance 2400 illustrated in FIG. 24, the minimum PA backoffs to have within 1 dB shift at 1% PER from the case without PA.

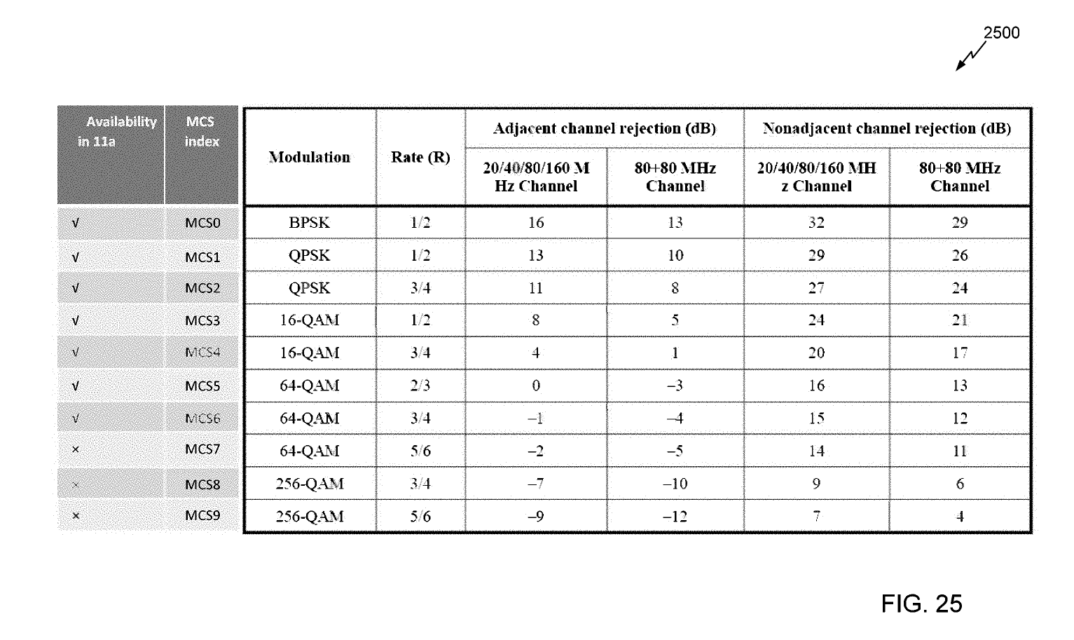

The higher sensitivity of higher MCS to ACI is mainly taken care of by reducing ACI power, as is illustrated in FIG. 25. FIG. 25 is a table 2500 of the minimum required adjacent and nonadjacent channel rejection levels. Therefore, the ACI rejection capability of different MCSs, given different relative ACI power levels, may be similar.

### Tone Plan Design for Impacted RUs

In view of the foregoing, the wireless system can enforce a minimum 8-tone guard band between null SB transmissions and channel bonded transmissions. In various embodiments, a system operating in the null sub-bands should have their own guard bands in the sub-bands. For example, a WiFi system operating in the null sub-bands would have a smallest guard band defined by an IEEE 802.11ax HE20 tone plan (e.g., 6 left guard tones (6ΔF4x) and 5 right guard tones (5ΔF4x)). Therefore, each frequency chunk in channel bonding embodiments herein has at least 3 guard tones (3ΔF4x) on the left and 2 guard tones (2ΔF4x) on the right (thereby creating a cumulative guard band of 8 tones on the left and 8 tones on the right). Referring back to FIG. 5C, the 1st and 4th 242-tone RUs 581 and 584 (and/or the smaller RUs shown above them) meet this design goal. Similarly, each 40 MHz half tone plan 550 also satisfies this design goal. On the other hand, although the 2^{nd} 242-tone RU 585 only overlaps the first PHY 20 MHz SB 581 by 2 tones, an additional 3 guard tones are needed on the left. Accordingly, a total of 5 tones are impacted in the 2^{nd} 242-tone RU 585 when the first PHY 20 MHz SB 581 is null.

On the other hand, the 2nd 242-tone RU 582 has at least 5 impacted tones at its left at tone indices {−254, −255, −256, −257} (similarly in the 10th 26-tone RU, 5th 52-tone RU, 3rd 106-tone RU, and 2nd 242-tone RU), and −258 (in the 2nd 242-tone RU). Moreover, the 3rd 242-tone RU 583 has at least 5 impacted tones at its right at tone indices {254, 255, 256, 257} (similarly in the 28 the 26-tone RU, 12th 52-tone RU, 6th 106-tone RU, 3rd 242-tone RU}, 258 (in the 3rd 242-tone RU).

In one embodiment, tone plans defined in IEEE 802.11ax can be used for channel bonding. For example, the HE20 tone plan can be used for all PHY 20 MHz SBs. Similarly, HE20/HE40/HE80 tone plans can be used for each frequency chunk of 20/40/80 MHz (where frequency chunk refers to a bonded combination of SBs). As IEEE 802.11ac does not define a 60 MHz tone plan, a combination of HE20 and HE40 (e.g., HE20+HE40 or HE40+HE20) can be used.

In other embodiments, modified tone plans (or a mix of modified and unmodified tone plans) can be used. With respect to modified tone plans, one or more of the following rules (in any combination) can be applied: The 1st and 4th 242-tone RUs 581 and 584 (and/or the smaller RUs shown above them) can be used in channel bonding without modification. This rule applies to all scenarios having [1], [4], [5], [8] as components in channel bonding combinations. The 1st and 2nd half 550C of the HE80 tone plan can be used in channel bonding without modification. This rule applies to all scenarios having [1+2], [3+4], [5+6], [7+8] as components in channel bonding combinations. The 2nd 242-tone RU 582 (and/or the smaller RUs shown above it) can be used in channel bonding without modification, only when [1+2] or [5+6] is used in the channel bonding combination. If [2] is used in the channel bonding combination without [1] (or [6] without [5]), which means it's used as the left-most (lower frequency) edge of a frequency chunk, the impacted RUs (the RUs with the impacted tones) can receive special treatment (discussed below), while other RUs could be used without modification. The 3rd 242-tone RU 583 (and/or the smaller RUs shown above it) can be used in channel bonding without modification, only when [3+4] or [7+8] is used in the channel bonding combination. If [3] is in channel bonding without [4] (or [7] without [8]), which means it's used as the right-most (higher frequency) edge of a frequency chunk, the impacted RUs (the RUs with the impacted tones) can receive special treatment (discussed below), while other RUs could be used without modification. If [2] or [3] but not [2+3] ([6] or [7] but not [6+7]) is used in the channel bonding combination, the 13-tone split of the center 26-tone may not be assigned as an RU and may be simply not used or used to carry data for other impacted RUs.

### Treatment for Impacted RUs

As discussed above, various RUs can have one or more impacted tones in each channel bonding scenario. According to various embodiments, one or more special treatments can be applied to the impacted tones in order to reduce or mitigate interference.

In one embodiment, impacted RUs (e.g., RUs containing at least one impacted tone) can be nulled out to create a sufficient guard band in the channel bonding chunk. For example, the AP 104 (and STAs 106A-106D) can refrain from assigning nulled RUs. As another example, the AP 104 (and STAs 106A-106D) can assign nulled RUs but not transmit data on them. In some embodiments, the AP 104 (and STAs 106A-106D) only nulls out impacted RUs of smaller size (e.g., below a threshold such as 26- and 52-tone RUs), and can use the impacted RUs above the threshold (e.g., 106- and 242-tone RUs) with puncturing of (e.g., not using or transmitting) the impacted tones.

In another embodiment, the AP 104 (and STAs 106A-106D) can puncture (e.g., refrain from transmitting on) specific impacted tones to create a sufficient guard band. Accordingly, impacted RUs containing punctured tones will effectively become smaller RUs (e.g., 22-tone RU, 48-tone RU, 102-tone RU, 237-tone RU). In some embodiments, the AP 104 (and STAs 106A-106D) can reuse the same binary convolutional code (BCC) interleaver and low density parity check (LDPC) tone mapper for these smaller RUs, and can skip the punctured tones.

In another embodiment, the AP 104 (and STAs 106A-106D) can apply a shifted tone plan by moving the data on impacted tones to elsewhere. For example, the shifted tone plan can move data on impacted tones to null tones, a 13-tone half of an unassigned boundary-crossing 26-tone block, guard tones in other PHY 20 MHz SBs where enough guard tones are already reserved, and so on. For example, in a [2]+[4] channel bonding combination, the data on impacted tone indices −254, −255, −256, −257, −258 can be moved to tones −16, −15, −14, −13, −12 (where the 13-tone split is not assigned). As another example, in a [2]+[3+4] channel bonding combination, the data on impacted tone indices −254, −255, −256, −257, −258 can be moved to tones+501, +502, +503, +504, +505 if 242-tone RUs are used. As another example, they can be moved to null tones (e.g., −17, −124, −151, +17, +124) if smaller RUs are used.

### Independent Encoding in Contiguous Channel Bonding

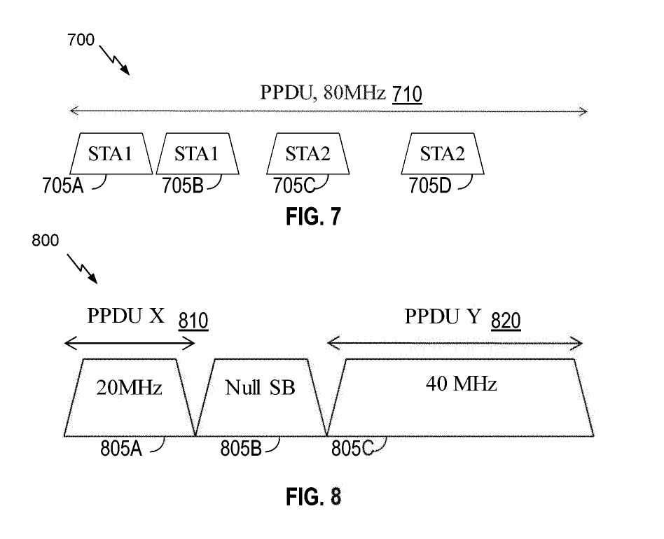

As discussed above, the allocations can be contiguous or non-contiguous in various embodiments. In either case, in some embodiments, multiple RUs allocated to the same STA can be independently encoded. For example, contiguous RUs can be allocated to a first STA, and non-contiguous RUs can be allocated to a second STA, as shown in FIG. 7. In various embodiments herein, independent encoding can refer to at least the use of separate encoders to produce separate outputs for each sub-channel or RU in parallel, the use of a single encoder to produce separate outputs for each sub-channel or RU serially, encodings where the content of one sub-channel does not change the output of encoding for another sub-channel, or any combination thereof.

FIG. 7 shows an example 80 MHz transmission 700 including four RUs 705A-705D for two user allocations, according to one embodiment. Although FIG. 7 shows one example 80 MHz transmission 700, other transmission sizes can be used, RUs can be added, omitted, rearranged, reallocated, or resized in various embodiments. For example, in various embodiments, the teachings of transmission 700 can be applied to any of the tone plans or transmission discussed herein.

As shown in FIG. 7, the transmission 700 includes a PPDU 710. Within the PPDU 710, contiguous RUs 705A-705B can be allocated to a STA1, which in some embodiments can be the STA 106A of FIG. 1. Non-contiguous RUs 705C-705D can be allocated to a STA2, which in some embodiments can be the STA 106B of FIG. 1. Each of the RUs 705A-705B allocated to STA1 can be encoded independently from each other. Likewise, each of the RUs 705C-70D allocated to STA2 can be encoded independently from each other. In various embodiments, each of the RUs 705A-705D can include any combination of tone blocks discussed herein, for example, the 26-, 52-, 106-, 107-, 108- and/or 242-tone blocks. Moreover, in some embodiments, other tone block sizes can be contemplated such as, for example, 102-tone blocks.

In various embodiments, in UL OFDMA embodiments, the AP 104 receives all packets. For example, the AP 104 can receive the PPDU 710 from the STA1 and the STA2. In some embodiments, the AP 104 transmits the PPDU 710 in a DL OFDMA mode.

### Independent PPDUs for Non-Contiguous Channels

As discussed above, in some embodiments, all RUs 705A-705D can be included in the same PPDU 710. In other embodiments, non-contiguous channels can be transmitted and received as separate PPDUs, as shown in FIG. 8.

FIG. 8 shows an example 80 MHz transmission 800 including two transmissions in FDM manner, according to one embodiment. The transmission 800 includes three sub-bands 805A-805C. Although FIG. 8 shows one example 80 MHz transmission 800, other transmission sizes can be used, sub-bands can be added, omitted, rearranged, reallocated, or resized in various embodiments. For example, in various embodiments, the teachings of transmission 800 can be applied to any of the tone plans or transmission discussed herein.

As shown in FIG. 8, the transmission 800 includes a first PPDU X 810 and a second PPDU Y 820. The first PPDU X 810 includes a 20 MHz sub-band 805A. A null sub-band 805B separates the first PPDU X 810 and the second PPDU Y820. The second PPDU Y 820 includes a 40 MHz sub-band 805C. Accordingly, the sub-bands 805A and 805C can be non-contiguous.

In various embodiments, separate resource allocation can be done on different sub-band. In various embodiments, different sub-bands can include different tone plans. Merely as an example, the 20 MHz sub-band 805A can be scheduled to one group of users, while the 40 MHz sub-band 805C can be scheduled to another group of users. In some embodiments, the 242-tone block boundary may not be aligned with a physical 20 MHz boundary. Accordingly, in some embodiments, separate FFTs can be used for each sub-band 805A and 805C, for example in embodiments where sub-bands can be far apart. In various embodiments herein, separate FFTs can refer to at least the use of separate processors to produce outputs from distinct input data for each sub-channel or RU in parallel, the use of a single processor produce outputs from distinct input data for each sub-channel or RU serially, transformations where the content of one sub-channel does not change the output of the FFT for another sub-channel, or any combination thereof.

In various embodiments, each sub-band 805A and 805C can include an independent PPDU. For example, the sub-band 805A can include a 1× legacy PPDU. At the same time, the sub-band 805C can include a 4×802.11ax PPDU.

In various embodiments, the number of non-contiguous modes can be reduced or limited. For example, the AP 104 can restrict combinations of non-contiguous BWs and/or limit the non-contiguous bands to a limit (for example, 2). In other embodiments, the AP 104 can limit combinations of non-contiguous BWs to those non-contiguous bands separated by a pre-defined null sub-band.

### DL/UL Support for Non-Contiguous Channel Bonding

In some embodiments, the transmission 800 of FIG. 8 can include a DL SU transmission. In DL SU embodiments, transmissions can include pairs of X+Y PPDUs, for example where X and Y PPDUs can be defined in the 802.11ax standard and can be transmitted in an OFDM/FDM manner. For example, X+Y can include 20+40 PPDUs, 20+20 PPDUs, 40+40 PPDUs, and so on.

In some embodiments, the transmission 800 of FIG. 8 can include an UL SU transmission. In UL SU embodiments, transmissions can include pairs of X+Y PPDUs, for example where X and Y PPDUs can be defined in the 802.11ax and/or 802.11ac standard and can be transmitted in an OFDM/FDM manner. For example, X+Y can include 20+40 PPDUs, 20+20 PPDUs, 40+40 PPDUs, 80+80 PPDUs, and so on.

In some embodiments, the transmission 800 of FIG. 8 can include a DL OFDMA/FDMA transmission. In DL OFDMA/FDMA embodiments, transmissions can include two separate OFDMA transmissions each addressed to a different group of users, or example where X and Y PPDUs can be defined in the 802.11ax and/or legacy standards. For example, X+Y can include 11ax+legacy PPDUs, 11ax+11ax PPDUs, 80+80 legacy PPDUs, and so on.

In some embodiments, the transmission 800 of FIG. 8 can include an UL OFDMA/FDMA transmission. In UL OFDMA/FDMA embodiments, transmissions can include pairs of X+Y PPDUs, where X and Y PPDUs can be defined in the 802.11ax and/or legacy standards. In some embodiments where both X and Y can be 802.11ax PPDUs, any RU/BW size is contemplated.

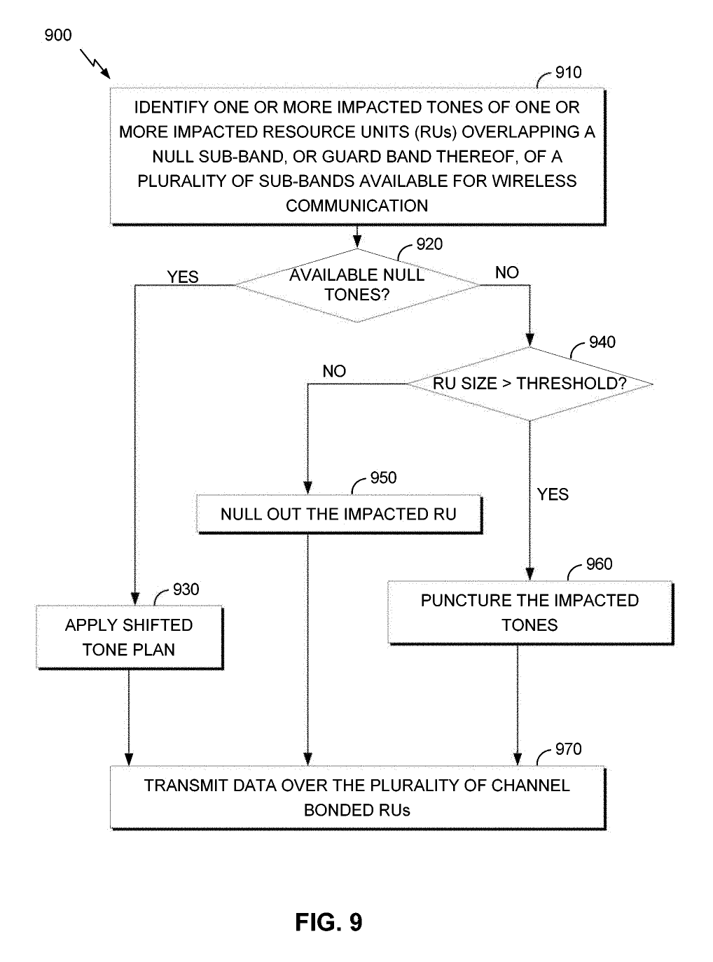

FIG. 9 shows a flowchart 900 for an example method of communicating over a wireless communication network. The method may be used to allocate and bond contiguous or non-contiguous resource allocations to one or more wireless devices. The method can be implemented in whole or in part by the devices described herein, such as the wireless device 202 shown in FIG. 2 or the AP 104 or STAs 106A-106D shown in FIG. 1. Although the illustrated method is described herein with reference to the wireless communication system 100 discussed above with respect to FIG. 1, and the transmissions 500A-800 discussed above with respect to FIGS. 5A-8, a person having ordinary skill in the art will appreciate that the illustrated method can be implemented by another device or transmission described herein, or any other suitable device or transmission. Although the illustrated method is described herein with reference to a particular order, in various embodiments, blocks herein can be performed in a different order, or omitted, and additional blocks can be added.

At block 910, a wireless device allocates identifies one or more impacted tones of one or more resource units (RUs) overlapping a null sub-band, or guard band thereof, of a plurality of sub-bands available for wireless communication. The wireless device can include, for example, the AP 104 or any of the STAs 106A-106D. Based at least in part on the identified impacted tones/RUs, the wireless device can allocate (or receive allocation of, for example in the case of the STAs 106A-106D) a plurality of channel bonded resource units (RU). In various embodiments, said allocating can include nulling out the impacted RUs, puncturing the impacted tones, and/or applying a shifted tone plan as discussed herein. For example, the wireless device can determine which treatment to apply according to the following decision points.

At block 920, the wireless device can determine whether sufficient available null tones exist to apply a shifted tone plan. For example the wireless device can count the number of null tones not impacted or otherwise assigned (such as null tones between RUs or portions of RUs that are not assigned). If the number of available null tones is sufficient to provide an error rate above a threshold (for example) the wireless device can apply the shifted tone plan (discussed herein) at block 930. Otherwise, the wireless device can proceed to block 940.

Then, at block 940, the wireless device can determine, for each impacted RU, whether the RU is above a threshold size. The threshold can be, for example, 26 tones, 56 tones, 106 tones, 242 tones, and so on. In some embodiments, the threshold can be large enough such that all RUs are below the threshold or small enough such that all RUs are above the threshold. If the impacted RU is greater than the threshold size, the wireless device can proceed to null out the entire impacted RU at block 950. On the other hand, if the impacted RU is smaller than or equal to the threshold size, the wireless device can proceed to puncture just the impacted tones at block 960.

Next, at block 970, the wireless device transmits data over the plurality of channel bonded RUs. For example, the wireless device can transmit the data according to the unmodified or shifted tone plan, depending on which tone plan was selected. Similarly, transmission can include punctured impacted tones or nulled RUs. In the case of punctured tones, the wireless device can include a transmitter that uses the same binary convolutional code (BCC) interleaver and low density parity check (LDPC) tone mapper for both punctured and unpunctured transmissions.

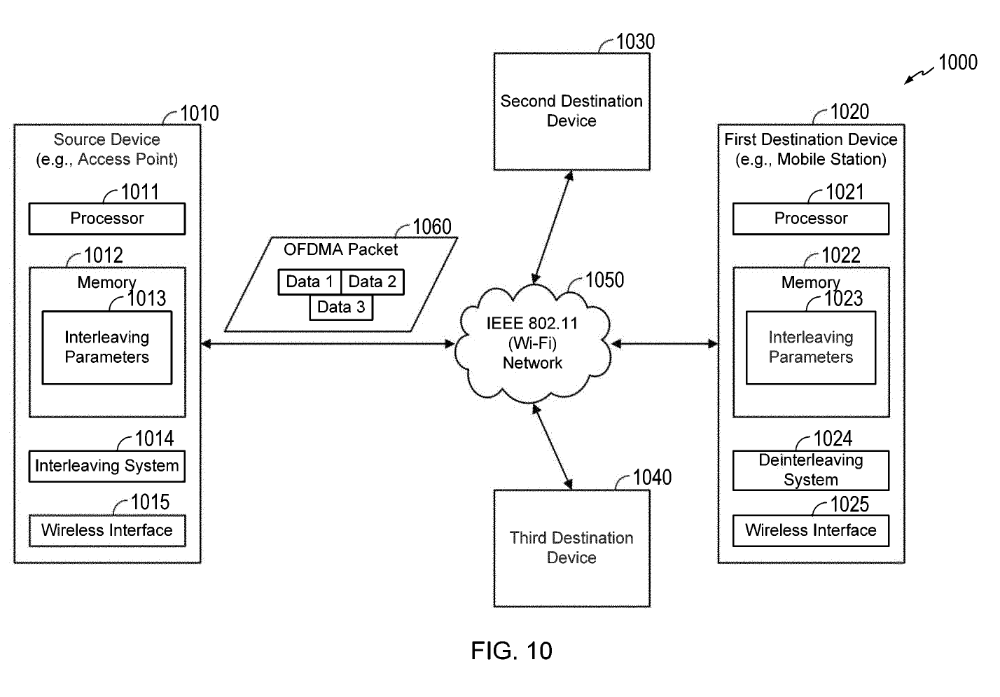

FIG. 10 shows a system 1000 that is operable to generate interleaving parameters for orthogonal frequency-division multiple access (OFDMA) tone plans, according to an embodiment. The system 1000 includes a first device (e.g., a source device) 1010 configured to wirelessly communicate with a plurality of other devices (e.g., destination devices) 1020, 1030, and 1040 via a wireless network 1050. In alternate embodiments, a different number of source devices destination devices can be present in the system 1000. In various embodiments, the source device 1010 can include the AP 104 (FIG. 1) and the other devices 1020, 1030, and 1040 can include STAs 106 (FIG. 1). The system 1000 can include the system 100 (FIG. 1). In various embodiments, any of the devices 1010, 1020, 1030, and 1040 can include the wireless device 202 (FIG. 2).

In a particular embodiment, the wireless network 1050 is an Institute of Electrical and Electronics Engineers (IEEE) 802.11 wireless network (e.g., a Wi-Fi network). For example, the wireless network 1050 can operate in accordance with an IEEE 802.11 standard. In a particular embodiment, the wireless network 1050 supports multiple access communication. For example, the wireless network 1050 can support communication of a single packet 1060 to each of the destination devices 1020, 1030, and 1040, where the single packet 1060 includes individual data portions directed to each of the destination devices. In one example, the packet 1060 can be an OFDMA packet, as further described herein.

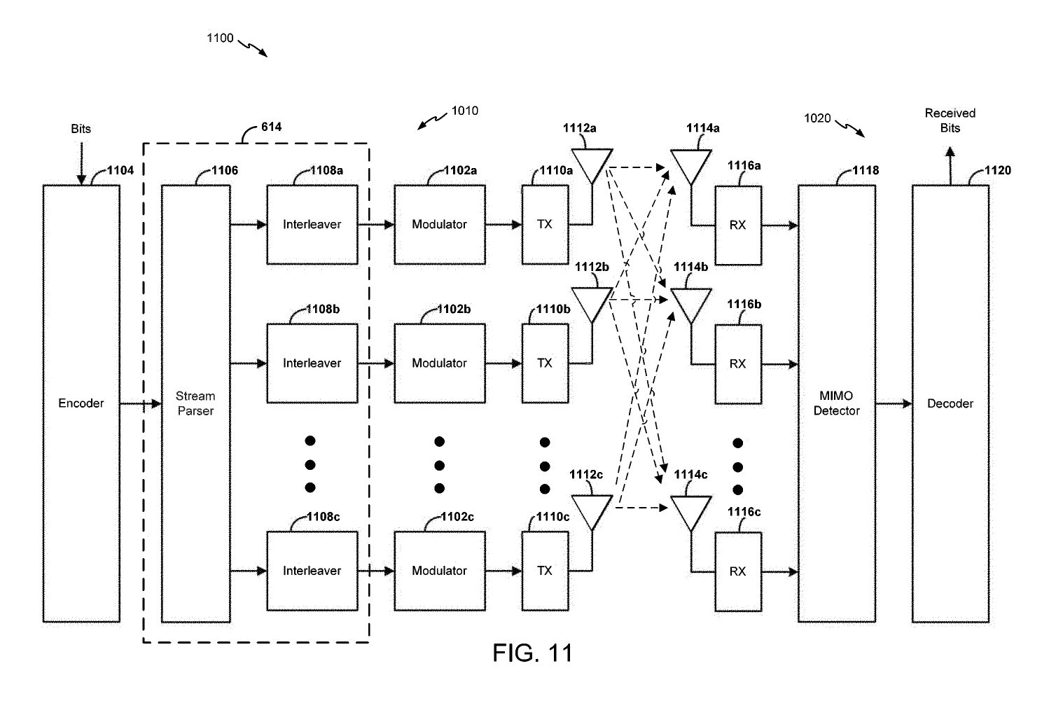

The source device 1010 can be an access point (AP) or other device configured to generate and transmit multiple access packet(s) to multiple destination devices. In a particular embodiment, the source device 1010 includes a processor 1011 (e.g., a central processing unit (CPU), a digital signal processor (DSP), a network processing unit (NPU), etc.), a memory 1012 (e.g., a random access memory (RAM), a read-only memory (ROM), etc.), and a wireless interface 1015 configured to send and receive data via the wireless network 1050. The memory 1012 can store binary convolutional code (BCC) interleaving parameters 1013 used by an interleaving system 1014 to interleave data according to the techniques described with respect to an interleaving system 1014 of FIG. 11.

As used herein, a “tone” can represent a frequency or set of frequencies (e.g., a frequency range) within which data can be communicated. A tone can alternately be referred to as a subcarrier. A “tone” can thus be a frequency domain unit, and a packet can span multiple tones. In contrast to tones, a “symbol” can be a time domain unit, and a packet can span (e.g., include) multiple symbols, each symbol having a particular duration. A wireless packet can thus be visualized as a two-dimensional structure that spans a frequency range (e.g., tones) and a time period (e.g., symbols).

As an example, a wireless device can receive a packet via a 20 megahertz (MHz) wireless channel (e.g., a channel having 20 MHz bandwidth). The wireless device can perform a 256-point fast Fourier transform (FFT) to determine 256 tones in the packet. A strict subset of the tones can be considered “useable” and the remaining tones can be considered “unusable” (e.g., can be guard tones, direct current (DC) tones, etc.). To illustrate, 238 of the 256 tones can be useable, which may include a number of data tones and pilot tones.

In a particular embodiment, the interleaving parameters 1013 can be used by the interleaving system 1014 during generation of the multiple access packet 1060 to determine which data tones of the packet 1060 can be assigned to individual destination devices. For example, the packet 1060 can include distinct sets of tones allocated to each individual destination device 1020, 1030, and 1040. To illustrate, the packet 1060 can utilize interleaved tone allocation.

The destination devices 1020, 1030, and 1040 can each include a processor (e.g., a processor 1021), a memory (e.g., a memory 1022), and a wireless interface (e.g., a wireless interface 1025). The destination devices 1020, 1030, and 1040 can also each include a deinterleaving system 1024 configured to deinterleave packets (e.g., single access packets or multiple access packets), as described with reference to a MIMO detector 1118 of FIG. 11. In one example, the memory 1022 can store interleaving parameters 1023 identical to the interleaving parameters 1013.

During operation, the source device 1010 can generate and transmit the packet 1060 to each of the destination devices 1020, 1030, and 1040 via the wireless network 1050. The packet 1060 can include distinct sets of data tones that can be allocated to each individual destination device according to an interleaved pattern.

The system 1000 of FIG. 10 can thus provide OFDMA data tone interleaving parameters for use by source devices and destination devices to communicate over an IEEE 802.11 wireless network. For example, the interleaving parameters 1013, 1023 (or portions thereof) can be stored in a memory of the source and destination devices, as shown, can be standardized by a wireless standard (e.g., an IEEE 802.11 standard), etc. It should be noted that various data tone plans described herein can be applicable for both downlink (DL) as well as uplink (UL) OFDMA communication.

For example, the source device 1010 (e.g., an access point) can receive signal(s) via the wireless network 1050. The signal(s) can correspond to an uplink packet. In the packet, distinct sets of tones can be allocated to, and carry uplink data transmitted by, each of the destination devices (e.g., mobile stations) 1020, 1030, and 1040.

FIG. 11 shows an example multiple-input-multiple-output (MIMO) system 1100 that can be implemented in wireless devices, such as the wireless device of FIG. 10, to transmit and receive wireless communications. The system 1100 includes the first device 1010 of FIG. 10 and the destination device 1020 of FIG. 10.

The first device 1010 includes an encoder 1104, the interleaving system 1014, a plurality of modulators 1102a-1102c, a plurality of transmission (TX) circuits 1110a-1110c, and a plurality of antennas 1112a-1112c. The destination device 1020 includes a plurality of antennas 1114a-1114c, a plurality of receive (RX) circuits 1116a-1116c, a MIMO detector 1118, and a decoder 1120.

A bit sequence can be provided to the encoder 1104. The encoder 1104 can be configured to encode the bit sequence. For example, the encoder 1104 can be configured to apply a forward error correcting (FEC) code to the bit sequence. The FEC code can be a block code, a convolutional code (e.g., a binary convolutional code), etc. The encoded bit sequence can be provided to the interleaving system 1014.

The interleaving system 1014 can include a stream parser 1106 and a plurality of spatial stream interleavers 1108a-1108c. The stream parser 1106 can be configured to parse the encoded bit stream from the encoder 1104 to the plurality of spatial stream interleavers 1108a-1108c.

Each interleaver 1108a-1108c can be configured to perform frequency interleaving. For example, the stream parser 1106 can output blocks of coded bits per symbol for each spatial stream. Each block can be interleaved by a corresponding interleaver 1108a-1108c that writes to rows and reads out columns. The number of columns (Ncol), or the interleaver depth, can be based on the number of data tones (Ndata). The number of rows (Nrow) can be a function of the number of columns (Ncol) and the number of data tones (Ndata). For example, the number of rows (Nrow) can be equal to the number of data tones (Ndata) divided by the number of columns (Ncol) (e.g., Nrow=Ndata/Ncol).

### Implementing Technology

A person/one having ordinary skill in the art would understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Various modifications to the implementations described in this disclosure can be readily apparent to those skilled in the art, and the generic principles defined herein can be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “example” is used exclusively herein to mean “serving as an example, instance, or illustration.” Any implementation described herein as “example” is not necessarily to be construed as preferred or advantageous over other implementations.

Certain features that can be described in this specification in the context of separate implementations also can be implemented in combination in a single implementation. Conversely, various features that can be described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

The various operations of methods described above can be performed by any suitable means capable of performing the operations, such as various hardware and/or software component(s), circuits, and/or module(s). Generally, any operations illustrated in the Figures can be performed by corresponding functional means capable of performing the operations.

The various illustrative logical blocks, modules and circuits described in connection with the present disclosure can be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor can be a microprocessor, but in the alternative, the processor can be any commercially available processor, controller, microcontroller or state machine. A processor can also be implemented as a combination of computing devices, e.g., a combination of a DSP and a microprocessor, a plurality of microprocessors, one or more microprocessors in conjunction with a DSP core, or any other such configuration.

In one or more aspects, the functions described can be implemented in hardware, software, firmware, or any combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave can be included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium can comprise non-transitory computer readable medium (e.g., tangible media). In addition, in some aspects computer readable medium can comprise transitory computer readable medium (e.g., a signal). Combinations of the above should also be included within the scope of computer-readable media.

The methods disclosed herein comprise one or more steps or actions for achieving the described method. The method steps and/or actions can be interchanged with one another without departing from the scope of the claims. In other words, unless a specific order of steps or actions is specified, the order and/or use of specific steps and/or actions can be modified without departing from the scope of the claims.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

While the foregoing is directed to aspects of the present disclosure, other and further aspects of the disclosure can be devised without departing from the basic scope thereof, and the scope thereof is determined by the claims that follow.

What is claimed is:

1. An apparatus configured to communicate over a wireless communication network, comprising:
a memory that stores instructions;
a processor coupled with the memory, wherein the processor and the memory are configured to:
identify one or more impacted tones of one or more resource units (RUs) overlapping a null sub-band, or guard band thereof, of a plurality of sub-bands available for wireless communication; and
allocate, or receive allocation of, a plurality of channel bonded resource units (RUs) within the plurality of sub-bands, based at least in part on the one or more impacted tones; and
a transmitter configured to transmit data over the plurality of channel bonded RUs.

2. The apparatus of claim 1, wherein the processor is configured to allocate the plurality of channel bonded RUs by nulling out at least one of the one or more RUs.

3. The apparatus of claim 1, wherein the transmitter is configured to puncture at least one of the one or more impacted tones.

4. The apparatus of claim 3, wherein the transmitter comprises a binary convolutional code (BCC) interleaver and a low density parity check (LDPC) tone mapper, and wherein the binary convolutional code (BCC) interleaver and the low density parity check (LDPC) tone mapper are configured for transmission of both punctured and unpunctured transmissions.

5. The apparatus of claim 1, wherein the processor is configured to allocate the plurality of channel bonded RUs by applying a shifted tone plan in which data on the one or more impacted tones is moved to another portion of a tone plan.

6. The apparatus of claim 5, wherein the processor determines if a sufficient number of null tones are not impacted or otherwise assigned that will provide an error rate above a threshold for applying the shifted tone plan.

7. The apparatus of claim 1, wherein the processor is configured to allocate the plurality of channel bonded RUs by nulling out the one or more RUs equal to or less than a threshold size, and the transmitter is configured to puncture the one or more impacted tones of the one or more RUs greater than the threshold size.

8. The apparatus of claim 7, wherein the threshold is 26 tones.

9. A method of communicating over a wireless communication network, comprising:
identifying one or more impacted tones of one or more resource units (RUs) overlapping a null sub-band, or guard band thereof, of a plurality of sub-bands available for wireless communication;
allocating, or receiving allocation of, a plurality of channel bonded resource units (RU) within the plurality of sub-bands, based at least in part on the one or more impacted tones; and
transmitting data over the plurality of channel bonded RUs.

10. The method of claim 9, wherein said allocating comprises nulling out at least one of the one or more RUs.

11. The method of claim 9, wherein said transmitting comprises puncturing at least one of the one or more impacted tones.

12. The method of claim 11, wherein said transmitting comprises using a binary convolutional code (BCC) interleaver and a low density parity check (LDPC) tone mapper, and wherein the binary convolutional code (BCC) interleaver and the low density parity check (LDPC) tone mapper are used for transmitting both punctured and unpunctured transmissions.

13. The method of claim 9, wherein said allocating comprises applying a shifted tone plan in which data on the one or more impacted tones is moved to another portion of a tone plan.

14. The method of claim 13, wherein said allocating comprises determining if a sufficient number of null tones are not impacted or otherwise assigned that will provide an error rate above a threshold for applying the shifted tone plan.

15. The method of claim 9, wherein said allocating comprises nulling out the one or more RUs equal to or less than a threshold size, and said transmitting comprises puncturing the one or more impacted tones of the one or more RUs greater than the threshold size.

16. The method of claim 15, wherein the threshold is 26 tones.

17. An apparatus for communicating over a wireless communication network, comprising:
means for identifying one or more impacted tones of one or more resource units (RUs) overlapping a null sub-band, or guard band thereof, of a plurality of sub-bands available for wireless communication;
means for allocating, or receiving allocation of, a plurality of channel bonded resource units (RU) within the plurality of sub-bands, based at least in part on the one or more impacted tones; and
means for transmitting data over the plurality of channel bonded RUs.

18. The apparatus of claim 17, wherein said means for allocating comprises means for nulling out at least one of the one or more RUs.

19. The apparatus of claim 17, wherein said means for transmitting comprises means for puncturing at least one of the one or more impacted tones.

20. A non-transitory computer readable medium comprising code that, when executed, causes an apparatus to:
identify one or more impacted tones of one or more resource units (RUs) overlapping a null sub-band, or guard band thereof, of a plurality of sub-bands available for wireless communication;
allocate, or receive allocation of, a plurality of channel bonded resource units (RU) within the plurality of sub-bands, based at least in part on the one or more impacted tones; and
transmit data over the plurality of channel bonded RUs.
